(19) United States
(12) Patent Application Publication
(10) Pub. No.: US 2025/0227682 A1
(43) Pub. Date: Jul. 10, 2025

(54) TERMINAL, BASE STATION AND COMMUNICATION METHOD

(71) Applicant: NTT DOCOMO, INC., Tokyo (JP)

(72) Inventors: Shinya Kumagai, Chiyoda-ku, Tokyo (JP); Mayuko Okano, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 18/853,593

(22) PCT Filed: Apr. 14, 2022
(86) PCT No.: PCT/JP2022/017881

§ 371 Date: Oct. 2, 2024

(51) Int. Cl. H04W 72/0457; H04W 68/02; H04W 74/04; H04W 74/0833

(52) U.S. Cl. CPC H04W 72/0457; H04W 68/02; H04W 74/04; H04W 74/0833

(57) ABSTRACT

A terminal including: a communication unit configured to receive system information; and a control unit configured to assume that at least one of: a downlink bandwidth part for a non-reduced function terminal that is different from that for a first function-reduced terminal; or an uplink bandwidth part for the non-reduced function terminal that is different from that for the first function-reduced terminal, is to be configured. A second function that is different from a first function for the first function-reduced terminal is reduced from the terminal.

### FIELD OF THE INVENTION

The present invention relates to a terminal, a base station and a communication method in a wireless communication system.

### BACKGROUND OF THE INVENTION

Regarding NR (New Radio) (also referred to as “5G”), or a successor system to LTE (Long Term Evolution), technologies have been discussed which satisfy the following requirements: a high capacity system, high data transmission rate, low delay, simultaneous connection of multiple terminals, low cost, power saving, etc. (for example, Non-Patent Document 1).

In LTE or NR, a UE category or a UE capability for the function-reduced IoT (Internet of Things) in which functions, such as functions related to the transmission/reception bandwidth part or the number of antennas, to be mandatorily supported by normal terminals are removed. For example, in LTE, eMTC (enhanced Machine Type Communication), NB-IoT (Narrow Band IoT) are defined, and, in NR, RedCap (Reduced Capability), etc., are defined.

In addition, discussions related to a future system later than 5G, or 6G, have been started. In the future system, further improvement of communication performance and wider variety of use cases are expected.

### CITATION LIST

### Non-Patent Document

Non-Patent Document 1: 3GPP TS 38.300 V16.8.0 (2021-12)

### SUMMARY OF THE INVENTION

### Technical Problem

In the future systems (for example, NR release 18 and 6G that is an NR successor system), an eRedCap (enhanced Reduced Capability) in which functions are further reduced as compared with RedCap that is discussed in NR release 17 has been discussed. However, conventionally, how to configure the DL-BWP (Downlink Bandwidth part) and/or UL-BWP (Uplink Bandwidth part) supported by the eRedCap has been unclear.

The present invention has been made in view of the above points, and it is an object of the present invention to determine the frequency band to be used by the function-reduced terminals in the wireless communication system.

### Solution to Problem

According to the disclosed technology, a terminal is provided. The terminal includes: a communication unit configured to receive system information; and a control unit configured to assume that at least one of a downlink bandwidth part for a non-reduced function terminal that is different from that for a first function-reduced terminal; or an uplink bandwidth part for the non-reduced function terminal that is different from that for the first function-reduced terminal, is to be configured. A second function that is different from a first function for the first function-reduced terminal is reduced from the terminal.

### Advantageous Effects of Invention

According to the disclosed technique, a technique is provided that enables determination of the frequency band used by the function-reduced terminal in the wireless communication system.

### BRIEF DESCRIPTION OF THE DRAWINGS

FIG. 1 is a drawing for describing a wireless communication system related to an embodiment of the present invention.

FIG. 2 is a first drawing illustrating an example of BWP configuration for initial/random access in the RedCap UE for NR release 17.

FIG. 3 is a second drawing illustrating an example of BWP configuration for initial/random access in the RedCap UE for NR release 17.

FIG. 4 is a first drawing illustrating an example of BWP configuration for an idle/inactive/connected mode in the RedCap UE for NR release 17.

FIG. 5 is a second drawing illustrating an example of BWP configuration for an idle/inactive/connected mode in the RedCap UE for NR release 17.

FIG. 6 is a drawing for describing the relationship among embodiments of the present invention from a first embodiment to a third embodiment.

FIG. 7 is a first drawing illustrating an example of an operation of an eRedCap UE related to an embodiment of the present invention.

FIG. 8 is a second drawing illustrating an example of an operation of an eRedCap UE related to an embodiment of the present invention.

FIG. 9 is a third drawing illustrating an example of an operation of an eRedCap UE related to an embodiment of the present invention.

FIG. 10 is a first drawing illustrating an example of an overall operation of an eRedCap UE related to an embodiment of the present invention.

FIG. 11 is a second drawing illustrating an example of an overall operation of an eRedCap UE related to an embodiment of the present invention.

FIG. 12 is a third drawing illustrating an example of an operation of an eRedCap UE related to an embodiment of the present invention.

FIG. 13 is a drawing illustrating an example of a functional structure of a base station related to an embodiment of the present invention.

FIG. 14 is a drawing illustrating an example of a functional structure of a terminal related to an embodiment of the present invention.

FIG. 15 is a drawing illustrating an example of a hardware structure of the base station or the terminal related to an embodiment of the present invention.

FIG. 16 is a drawing illustrating an example of a structure of a vehicle related to an embodiment of the present invention.

### DETAILED DESCRIPTION OF THE PREFERRED EMBODIMENTS

In the following, referring to the drawings, one or more embodiments of the present invention will be described. It should be noted that the embodiments described below are examples. Embodiments of the present invention are not limited to the following embodiments.

In operations of a wireless communication system according to an embodiment of the present invention, a conventional technique will be used when it is appropriate. With respect to the above, for example, the conventional techniques are related to, but not limited to, the existing LTE. Further, it is assumed that the term “LTE” used in the present specification has, unless otherwise specifically mentioned, a broad meaning including a scheme of LTE-Advanced and a scheme after LTE-Advanced (e.g., NR).

Furthermore, in one or more embodiments described below, terms that are used in the existing LTE are used, such as SS (Synchronization signal), PSS (Primary SS), SSS (Secondary SS), PBCH (Physical broadcast channel), PRACH (Physical random access channel), PDCCH (Physical Downlink Control Channel), PDSCH (Physical Downlink Shared Channel), PUCCH (Physical Uplink Control Channel), PUSCH (Physical Uplink Shared Channel), etc. The above-described terms are used for the sake of description convenience. Signals, functions, etc., which are similar to the above-described terms, may be referred to as different names. Further, terms, which are used in NR and correspond to the above-described terms, are NR-SS, NR-PSS, NR-SSS, NR-PBCH, NR-PRACH, etc. However, even when a signal is used for NR, there may be a case in which the signal is not referred to as “NR-”.

In addition, in an embodiment of the present invention, the duplex method may be a TDD (Time Division Duplex) method, an FDD (Frequency Division Duplex) method, or any other method (e.g., Flexible Duplex, or the like).

Further, in an embodiment of the present invention, the expression, radio (wireless) parameters are “configured (set)” may mean that a predetermined value is pre-configured, or may mean that a radio parameter indicated by a base station 10 or a terminal 20 is configured.

### System Configuration

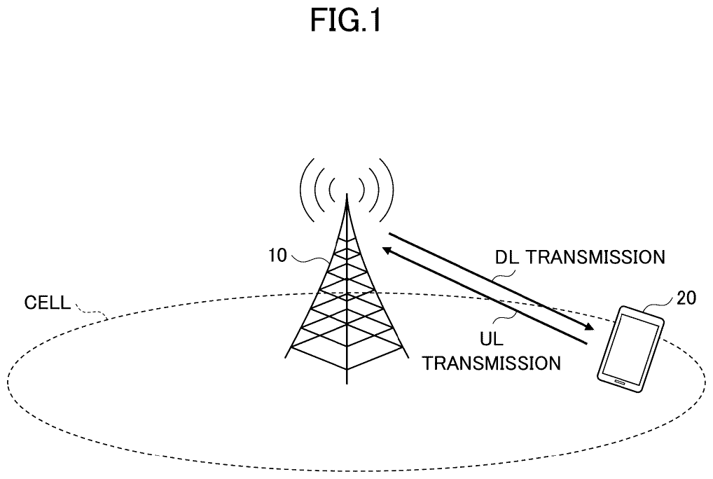

FIG. 1 is a drawing illustrating a wireless communication system related to an embodiment of the present invention. As illustrated in FIG. 1, the wireless communication system according to an embodiment of the present invention includes a base station 10 and a terminal 20. In FIG. 1, a single base station 10 and a single terminal 20 are illustrated as an example. There may be a plurality of base stations 10 and a plurality of terminals 20.

The base station 10 is a communication device that provides one or more cells and performs wireless communication with the terminal 20. Physical resources of radio signals may be defined in the time domain and the frequency domain, the time domain may be defined by the number of OFDM (Orthogonal Frequency Division Multiplexing) symbols, and the frequency domain may be defined by the number of sub-carriers or resource blocks. Further, a TTI (Transmission Time Interval) in the time domain may be a slot, or the TTI may be a subframe.

The base station 10 transmits a synchronization signal and system information to the terminal 20. The synchronization signal is, for example, an NR-PSS and an NR-SSS. The system information is transmitted via, for example, a NR-PBCH, and may be referred to as broadcast information. The synchronization signal and the system information may be referred to as an SSB (SS/PBCH block). As shown in FIG. 1, the base station 10 transmits a control signal or data in DL (Downlink) to the terminal 20 and receives a control signal or data in UL (Uplink) from the terminal 20. The base station 10 and terminal 20 are capable of transmitting and receiving a signal by performing the beamforming. Further, the base station 10 and the terminal 20 can both apply MIMO (Multiple Input Multiple Output) communication to DL or UL. Further, the base station 10 and the terminal 20 may both perform communications via a secondary cell (SCell: Secondary Cell) and a primary cell (PCell: Primary Cell) using CA (Carrier Aggregation). In addition, the terminal 20 may perform communications via a primary cell of the base station 10 and a primary secondary cell group cell (PSCell: Primary SCG Cell) of another base station 10 using DC (Dual Connectivity).

The terminal 20 may be a communication apparatus that includes a wireless communication function such as a smartphone, a mobile phone, a tablet, a wearable terminal, a communication module for M2M (Machine-to-Machine), or the like. As shown in FIG. 1, the terminal 20 uses various communication services provided by the wireless communication system by receiving control signals or data in DL from the base station 10 and transmitting control signals or data in UL to the base station 10. In addition, the terminal 20 receives various reference signals transmitted from the base station 10 and performs measurement of the propagation path quality based on the reception result of the reference signals. Note that the terminal 20 may be referred to as a UE, and the base station 10 may be referred to as a gNB.

In addition, in NR, as a continued discussion from LTE, a carrier aggregation function using a wide band in order to allocate data resources is being discussed. In the carrier aggregation function, wide band data resources can be allocated by bundling a plurality of component carriers.

### RedCap of NR Release 17

First, the conventional RedCap of NR release 17 will be described. The maximum bandwidth that is supported by a RedCap UE and that is being discussed in NR release 17 is 20 MHz in FR1 (Frequency Range 1) and 100 MHz in FR2 (Frequency Range 2). In addition, the RedCap UE is required to coexist with a non RedCap UE (hereinafter, also referred to as “non-RedCap UE”) within the system.

In addition, a RedCap UE and a non-RedCap UE may be enabled to share the same initial DL-BWP (Downlink Bandwidth part) (including the subcarrier spacing, bandwidth, and position) configured by MIB (Master Information Block). On the other hand, an initial DL-BWP having a separate or added subcarrier spacing, bandwidth, and position for the RedCap UE may be configured.

The RedCap UE can share the initial DL-BWP for non-RedCap UE (hereinafter, also referred to as “DL-BWP #0”) in a case where the maximum bandwidth supported by the RedCap UE is not exceeded.

In addition, in the NR release 17 technical specifications, in a case of TDD, a DL-BWP and a UL-BWP with the same index must have the same center frequency in order to avoid the RF retuning.

In addition, the RedCap UE expects that an initial DL-BWP and an active DL-BWP are to be equal to or less than the maximum DL bandwidth supported by the RedCap UE after the (re) establishment of the dedicated RRC connection. The RedCap UE is provided with a DL-BWP by “initialDownlinkBWP” in “Downlink ConfigCommonRedCapSIB”, and is provided with a UL-BWP by “initialUplinkBWP” in “UplinkConfigCommonRedCapSIB”. In a case where “initialUplinkBWP” in “UplinkConfigCommonSIB” indicates a UL-BWP that is larger than the maximum UL-BWP supported by the RedCap UE, the RedCap UE expects that a UL-BWP is to be provided by “initialUplinkBWP” in “Uplink ConfigCommonRedCapSIB”.

The RedCap UE may be provided with a DL-BWP by “BWP-DownlinkDedicated” other than the initial DL-BWP. The RedCap UE may be provided with a UL-BWP that is equal to or less than the maximum UL bandwidth supported by the RedCap UE by “BWP-UplinkDedicated” other than the initial UL-BWP.

In a case where the RedCap UE is provided with “RACH-ConfigCommon-RedCap” or “RACH-ConfigCommonTwoStepRA-RedCap”, the RedCap UE performs an initial access and random access procedure by using the corresponding parameters. Otherwise, the RedCap UE uses the corresponding parameters provided by “RACH-ConfigCommon” or “RACH-Config CommonTwoStepRA”.

In a case where the RedCap UE is provided with “initialUplinkBWP” by “UplinkConfigCommonRedCapSIB” and there is no dedicated PUCCH resource configuration, the RedCap UE transmits PUCCH with HARQ-ACK information by using the PUCCH resource set provided by “pucch-ResourceCommonRedCap”. It is to be noted that the PUCCH transmission is disabled in a case where “disable-FH-PUCCH” is provided by “PUCCH-ConfigCommonRedCap”.

With respect to the initial DL-BWP provided by “initialDownlinkBWP” in “Downlink ConfigCommonRedCapSIB”, in a case where the RedCap UE monitors PDCCH according to the Type1-PDCCH CSS set and does not monitor PDCCH according to the Type2-PDCCH CSS set, the RedCap UE determines that the initial DL-BWP does not include SS/PBCH blocks or the CORESET with index 0.

In a case where the RedCap UE monitors PDCCH according to the Type2-PDCCH CSS set, the RedCap UE assumes that the initial DL-BWP includes an SS/PBCH block and the CORESET with an index 0 if the RedCap UE has obtained SIB1 by using the SS/PBCH block and assumes that the initial DL-BWP includes an SS/PBCH block and does not include the CORESET with an index 0 if the initial DL-BWP does not include the SS/PBCH block that the RedCap UE has used to obtain SIB1.

In a case of an active DL-BWP provided by “BWP-DownlinkDedicated”, the RedCap UE assumes that the active DL-BWP includes an SS/PBCH block, unless the RedCap UE indicates a function of operating in the DL-BWP without receiving an SS/PBCH block, and does not include the CORESET with an index 0.

Next, the BWP configuration for the initial/random access in NR release 17 RedCap UE will be described by referring to the drawings.

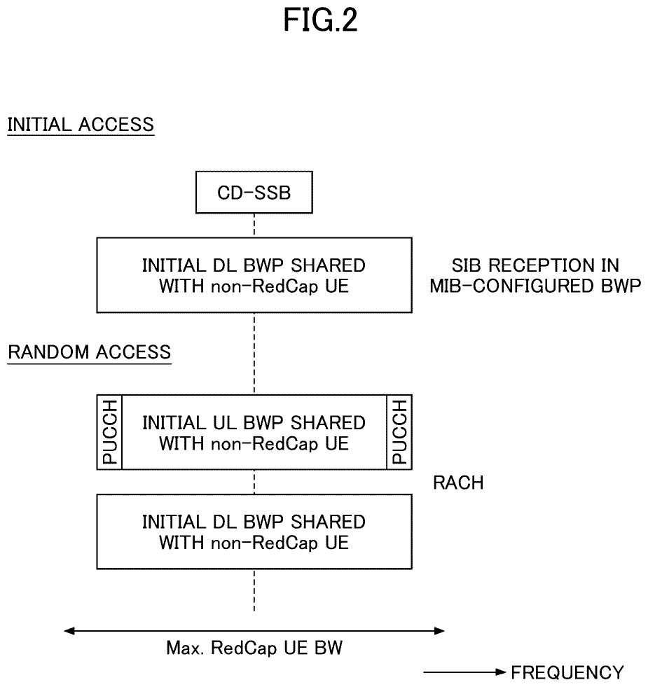

FIG. 2 is a first drawing illustrating an example of BWP configuration for initial/random access in the RedCap UE for NR release 17. In a case where the DL/UL-BWP #0 for the non-RedCap UE is equal to or less than the maximum bandwidth of the RedCap UE, the RedCap UE can support the conventional initial DL/UL-BWP operation. It is to be noted that the CD-SSB (cell defined SSB) in the drawing is an SSB the RedCap UE receives for obtaining SIB resources.

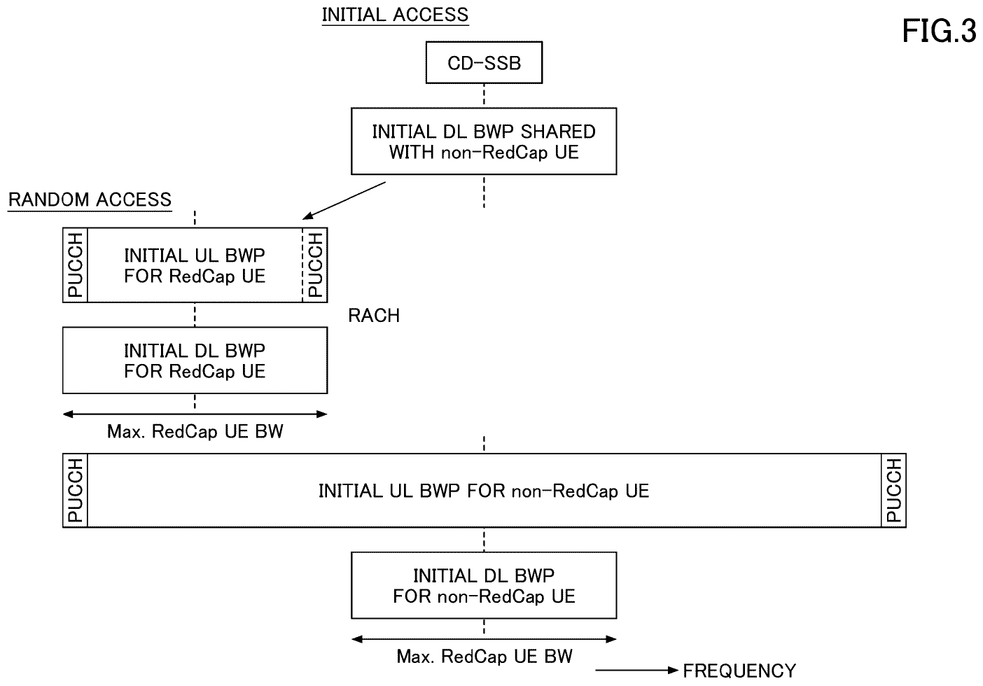

FIG. 3 is a second drawing illustrating an example of BWP configuration for initial/random access in the RedCap UE for NR release 17. The RedCap UE supports a random access procedure using a separate initial DL/UL-BWP in order to operate even in a case where the DL/UL-BWP #0 for the non-RedCap UE exceeds the maximum bandwidth of the RedCap UE.

The separate initial UL (or DL)-BWP is configured for the RedCap UE by using SIB. Here, there are a case in which a CD-SSB is included and a case in which a CD-SSB is not included. In order to avoid PUSCH fragmentation of the non-RedCap UE, FH (frequency hopping) can be disabled by using SIB. In addition, there are a case in which the PUCCH resource set is shared between the RedCap UE and the non-RedCap UE and a case in which the PUCCH resource set is not shared between the RedCap UE and the non-RedCap UE.

Next, the BWP configuration for an idle/inactive/connected mode in the RedCap UE for NR release 17 will be described.

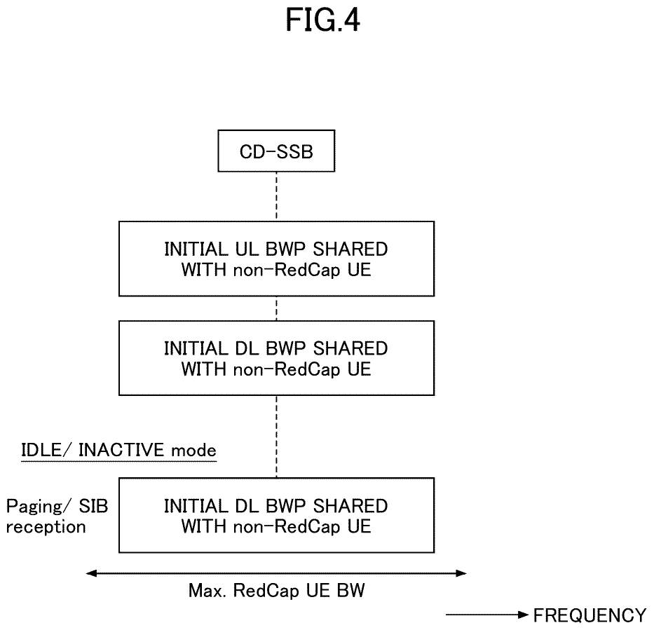

FIG. 4 is a first drawing illustrating an example of BWP configuration for an idle/inactive/connected mode in the RedCap UE for NR release 17. In a case where the DL/UL-BWP #0 for the non-RedCap UE is equal to or less than the maximum bandwidth of the RedCap UE, the RedCap UE can support the conventional initial DL/UL-BWP operation also for the idle/inactive mode transitioned from the connected mode.

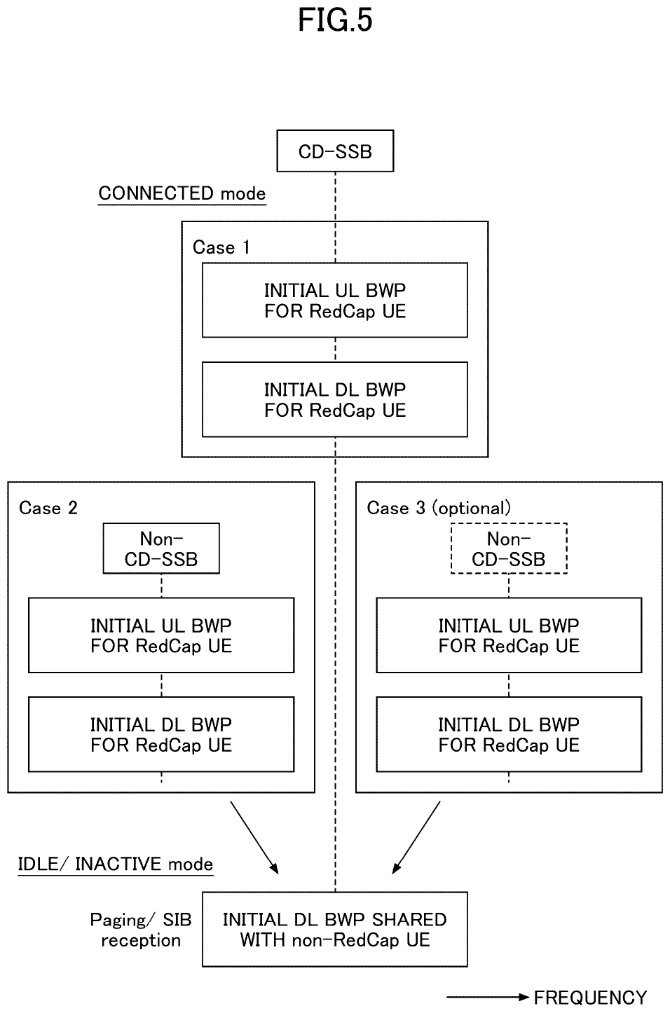

FIG. 5 is a second drawing illustrating an example of BWP configuration for an idle/inactive/connected mode in the RedCap UE for NR release 17. The RedCap UE supports a separate initial DL/UL-BWP for the connected mode.

For example, the RedCap UE supports a procedure of a case 1 including the CD-SSB. In addition, the RedCap UE supports a procedure of a case 2 including the non-CD-SSB (non-cell defined SSB). The Non-CD-SSB is an SSB that is configured in a case where the CD-SSB is not limited to be within the DL-BWP of the RedCap UE. In addition, the RedCap UE optionally supports a procedure of a case 3 in which neither CD-SSB nor non-CD-SSB is included. That is, the procedure of a case 3 is a BWP operation without using an SSB. In addition, in the procedure of a case 2 or case 3, as an option, the paging is not required to be configured for the BWP #0 configuration.

In addition, the RedCap UE supports a separate DL/UL-BWP in the RRC-configured active DL/UL-BWP. In this case, procedures from a case 1 to case 3 are also supported as in a case illustrated in FIG. 5.

### RedCap of NR Release 18

Next, discussions on the RedCap of NR release 18 will be described. In the NR release 18, the eRedCap for further reducing the complexity of the RedCap UE for the NR release 17 is being discussed. Hereinafter, the function-reduced terminal for NR release 17 is referred to as a RedCap UE and the enhanced function-reduced terminal for NR release 18 is referred to as an eRedCap UE in order to distinguish the two function-reduced terminals. The RedCap UE is an example of the first function-reduced terminal. The eRedCap UE is an example of the second function-reduced terminal. In other words, the first function-reduced terminal is a terminal in which the first function is reduced and the second function-reduced terminal is a terminal in which the second function that is different from the first function (including a case in which the first function and the second function are partially overlapped) is reduced.

The network impact, co-existence of the RedCap UE or eRedCap UE with non-RedCap UE in a cell, UE impact, technical specification impact, etc. are being discussed. The potential solutions, which may complement each other, for reducing the device complexity are focused on the following.

Reduction of the UE bandwidth in FR1 to 5 MHz is being discussed as the first solution. This solution may be combined with the relaxed UE processing timeline for PDSCH and/or PUSCH and/or CSI to be specified in the technical specifications.

The reduced UE peak data rate in FR1 is being discussed as the second solution. This solution may include the limited bandwidth for PDSCH and/or PUSCH, and may be combined with the relaxed UE processing timeline for PDSCH and/or PUSCH and/or CSI to be specified in the technical specifications.

It is to be noted that the following requirements may be applied to the eRedCap UE. That is, the SSB that has been specified in the technical specifications of NR release 15 may be reused so that the L1 changes are minimized. In addition, the BWP operations with/without SSB and with/without RF retuning are required to be discussed. Furthermore, it is not precluded that some solutions for FR1 can be applied to FR2. In addition, defining a single release 18 function-reduced terminal type for further reducing the UE complexity is being discussed.

### Problem of Conventional Technique

As described above, the eRedCap UE for NR release 18 is being discussed. However, there is a problem that whether or not an initial DL-BWP for the eRedCap UE and/or initial UL-BWP for the eRedCap UE are/is to be supported is unclear with respect to the following aspects.
Whether or not an eRedCap UE is to be separated from a non-RedCap UE or a RedCap UE, or how an eRedCap UE is to be separated from a non-RedCap UE or a RedCap UE
Whether or not TDD and/or FDD are/is to be supported
Whether or not FR1 and/or FR2 are/is to be supported
Whether or not an RRC idle/inactive/connected mode(s) is (are) to be supported
Whether or not the random access and/or paging are/is to be supported
Whether or not an SSB is to be included
Whether or not CORESET #0 is to be included
Whether or not the center frequency of the initial DL-BWP for the eRedCap UE is to be aligned with that of the initial UL-BWP
Whether or not the initial DL-BWP for the eRedCap UE and/or initial UL-BWP for the eRedCap UE are/is to be supported as a cell common configuration or as a UE-specific configuration

### Overview of Embodiment

Accordingly, in an embodiment of the present invention, the method of configuring the initial DL-BWP and/or initial UL-BWP for the eRedCap UE will be described. Hereinafter, embodiments from a first embodiment to a third embodiment will be described. It is to be noted that the terminal 20 in each of the embodiments is an eRedCap UE unless otherwise stated.

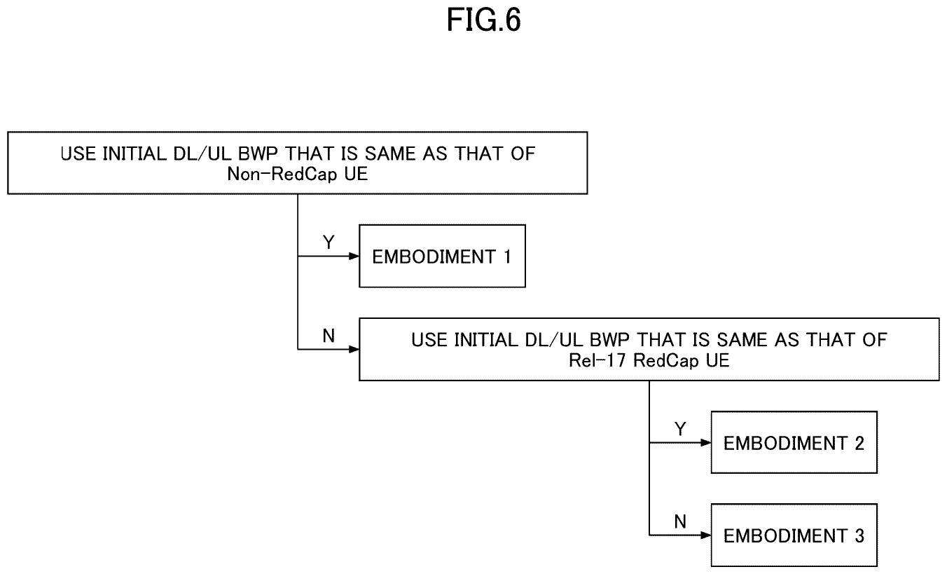

FIG. 6 is a drawing for describing the relationship among embodiments of the present invention from the first embodiment to the third embodiment. In the first embodiment, a case in which an eRedCap UE uses the same initial DL/UL-BWP as that for a non-RedCap UE will be described. In a second embodiment, a case in which an eRedCap UE uses the same initial DL/UL-BWP as that for a RedCap UE will be described. In the third embodiment, a case in which an eRedCap UE uses an initial DL/UL-BWP that is different from that for a non-RedCap UE or a RedCap UE will be described.

It is to be noted that the same or different embodiment may be applied to an eRedCap UE according to the following scenarios.
TDD/FDD
FR1/FR2
RRC idle/inactive/connected mode
Random access/paging/SIB reception

### First Embodiment

In this embodiment, a case in which an eRedCap UE uses the same initial DL/UL-BWP as that for a non-RedCap UE will be described.

The terminal 20 may use the same initial DL/UL-BWP as that for a non-RedCap UE.

In other words, the terminal 20 may use the MIB-configured initial DL-BWP (CORESET #0 band) and the initial DL-BWP configured by “initialDownlinkBWP” included in “Downlink ConfigCommonSIB”.

In addition, the terminal 20 may use the initial UL-BWP configured by “initialUplinkBWP” included in “UplinkConfigCommonSIB”.

### Option 1

The terminal 20 may use an initial DL/UL-BWP that is the same as that for a non-RedCap UE regardless of the bandwidth of the initial DL/UL-BWP.

In a case where the bandwidth of the initial DL/UL-BWP exceeds the maximum bandwidth of the eRedCap UE, the terminal 20 may expect that transmission and reception of DL/UL signals exceeding the maximum bandwidth are not to be performed.

### Option 2

The terminal 20 may use an initial DL/UL-BWP that is the same as that for a non-RedCap UE in accordance with the bandwidth of the initial DL/UL-BWP. For example, the terminal 20 may use an initial DL/UL-BWP that is the same as that for a non-RedCap UE only in a case where the bandwidth of the initial DL/UL-BWP does not exceed the maximum bandwidth of the eRedCap UE (for example, 5 MHz).

It is to be noted that the terminal 20 may perform an operation described below in the second embodiment or the third embodiment in a case where the bandwidth of the initial DL/UL-BWP exceeds the maximum bandwidth of the eRedCap UE (for example, 5 MHz).

### Second Embodiment

In this embodiment, a case in which an eRedCap UE uses the same initial DL/UL-BWP as that for a RedCap UE will be described.

The terminal 20 may use the same initial DL/UL-BWP as that for a RedCap UE.

In other words, the terminal 20 may use the initial DL-BWP configured by “initialDownlinkBWP” included in “Downlink Config CommonRedCapSIB”.

In addition, the terminal 20 may use the initial UL-BWP configured by “initialUplinkBWP” included in “Uplink Config CommonRedCapSIB”.

### Option 1

The terminal 20 may use an initial DL/UL-BWP that is the same as that for a RedCap UE regardless of the bandwidth of the initial DL/UL-BWP. In a case where the bandwidth of the initial DL/UL-BWP exceeds the maximum bandwidth (for example, 5 MHz) of the eRedCap UE, the terminal 20 may expect that transmission and reception of DL/UL signals exceeding the maximum bandwidth are not to be performed.

### Option 2

The terminal 20 may use an initial DL/UL-BWP that is the same as that for a RedCap UE in accordance with the bandwidth of the initial DL/UL-BWP. For example, the terminal 20 may use an initial DL/UL-BWP that is the same as that for a RedCap UE only in a case where the bandwidth of the initial DL/UL-BWP does not exceed the maximum bandwidth of the eRedCap UE (for example, 5 MHz).

It is to be noted that the terminal 20 may perform an operation described below in the third embodiment in a case where the bandwidth of the initial DL/UL-BWP exceeds the maximum bandwidth of the eRedCap UE (for example, 5 MHz).

### Third Embodiment

In this embodiment, a case in which an eRedCap UE uses an initial DL/UL-BWP that is different from that for a non-RedCap UE or a RedCap UE.

The terminal 20 may expect that at least one of the following is to be configured.
Initial DL-BWP that is different from a MIB-configured initial DL-BWP (CORESET #0 band) or from initial DL-BWPs that are configured by “initialDownlinkBWP” included in “Downlink Config CommonSIB” and “initialDownlinkBWP” included in “Downlink ConfigCommonRedCapSIB” (hereinafter, also referred to as DL-BWP #0-r18)
Initial UL-BWP that is different from initial UL-BWPs configured by “initialUplinkBWP” included in “UplinkConfigCommonSIB” and “initialUplinkBWP” included in “UplinkConfigCommonRedCapSIB” (hereinafter, also referred to as UL-BWP #0-r18)

The terminal 20 may expect that whether or not the DL-BWP #0-r18/UL-BWP #0-r18 can be configured for each of FDD/TDD and FR1/FR2 is to be specified in the technical specifications.

In a case where the DL-BWP #0-r18 or UL-BWP #0-r18 is configured, the terminal 20 may expect that which one of the following cases uses the DL-BWP #0-r18 or UL-BWP #0-r18 is to be specified in the technical specifications or is to be configured by a broadcast signal/upper layer signaling.
RRC idle/inactive/connected mode
Random access/paging/SIB reception

In each of the above-described cases in which the DL-BWP #0-r18 or UL-BWP #0-r18 is applied, the terminal 20 may expect that whether or not an SSB/CORESET #0 is included in the DL-BWP #0-r18 or UL-BWP #0-r18 is to be specified in the technical specifications, or is to be configured by a broadcast signal/upper layer signaling.

In addition, the terminal 20 may expect that the limitation related to the center frequency of the DL-BWP #0-r18 or UL-BWP #0-r18 is to be specified in the technical specifications.

The configuration of the DL-BWP #0-r18 and/or UL-BWP #0-r18 may be indicated by one of the conventional SIBs, may be indicated by SIB that is newly defined for the eRedCap UE, or may be indicated by RRC signaling specific to the terminal 20. For example, the DL-BWP #0-r18 and/or UL-BWP #0-r18 may be configured by the information elements described in 1) to 4) below. It is to be noted that the names of the information elements are mere examples, and may be different names.

1) “initialDownlinkBWP” included in “Downlink ConfigCommonRedCapSIB-r18” indicated by SIB
2) “initialUplinkBWP” included in “Uplink ConfigCommonRedCapSIB-r18” indicated by SIB
3) “initialDownlinkBWP” included in “DownlinkConfigRedCap-r18” indicated by RRC signaling specific to the terminal 20
4) “initialUplinkBWP” included in “UplinkConfigRedCap-r18” indicated by RRC signaling specific to the terminal 20

In a case where DL-BWP #0-r18 and/or UL-BWP #0-r18 are/is not configured, the terminal 20 may use the DL-BWP #0 and/or UL-BWP #0 for the non-RedCap UE.

For example, the terminal 20 may use the initial DL-BWP (CORESET #0 band) configured by MIB and/or the initial DL-BWP (DL-BWP #0) configured by “initialDownlinkBWP” included in “DownlinkConfigCommonSIB”. In addition, the terminal 20 may use the initial UL-BWP (UL-BWP #0) configured by “initialUplinkBWP” included in “UplinkConfigCommonSIB”. In addition, the terminal 20 may use the initial DL-BWP configured by “initialDownlinkBWP” included in “DownlinkConfigCommonRedCapSIB”. In addition, the terminal 20 may use the initial UL-BWP configured by “initialUplinkBWP” included in “Uplink ConfigCommonRedCapSIB”.

In a case where DL-BWP #0-r18 and/or UL-BWP #0-r18 are/is configured, the terminal 20 may determine that the configured BWP is to be BWP ID #0 for the RedCap UE. For example, in a case where DL-BWP #0-r18 and UL-BWP #0-r18 are both configured while performing communications by using the TDD method, the terminal 20 may expect a configuration in which the center frequency of DL-BWP #0-r18 and the center frequency of UL-BWP #0-r18 are to be identical, or may expect a configuration in which the center frequencies are to be different.

In addition, in a case where only DL-BWP #0-r18 is configured, the terminal 20 may expect a configuration in which the center frequencies of DL-BWP #0-r18 and UL-BWP #0 are to be identical, or may expect a configuration in which the center frequencies are to be different. In addition, in a case where only UL-BWP #0-r18 is configured, the terminal 20 may expect a configuration in which the center frequencies of UL-BWP #0-r18 and DL-BWP #0 are to be identical, or may expect a configuration in which the center frequencies are to be different.

In a case where the center frequencies of DL-BWP and UL-BWP are different, the terminal 20 may expect that the time for switching between UL-BWP and DL-BWP (RF retuning time) is to be specified in the technical specifications. For example, in a case where the terminal 20 performs switching from DL-BWP to UL-BWP, the terminal 20 may expect that the UL scheduling or UL configuration is to be not performed during the RF retuning time, or may determine whether or not to perform transmission based on the UE implementation. In addition, in a case where the terminal 20 performs switching from UL-BWP to DL-BWP, the terminal 20 may expect that the DL scheduling or DL configuration is to be not performed during the RF retuning time, or may determine whether or not to perform reception based on the UE implementation.

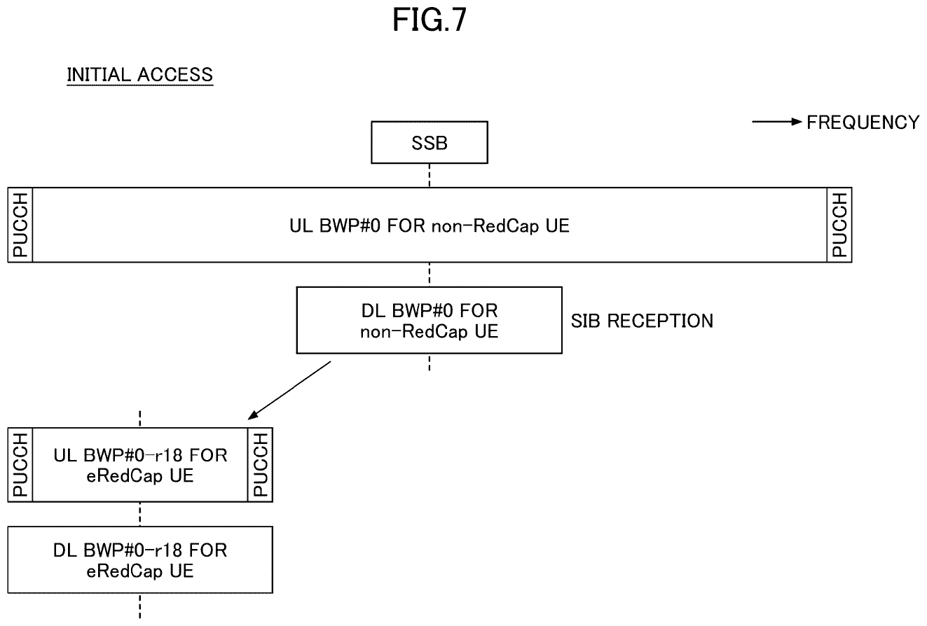

FIG. 7 is a first drawing illustrating an example of an operation of an eRedCap UE related to an embodiment of the present invention. FIG. 7 is an example in which DL-BWP #0-r18 and UL-BWP #0-r18 are configured by SIB. As illustrated in FIG. 7, the eRedCap UE receives SIB in DL-BWP #0 for the non-RedCap UE. DL-BWP #0-r18 that is different from DL-BWP #0 and UL-BWP #0-r18 that is different from UL-BWP #0 are configured by the SIB. It is to be noted that the width, the position of the frequency domain, etc., of each BWP are mere examples, and DL-BWP #0-r18 and UL-BWP #0-r18 may be arranged in the different frequency domain, for example.

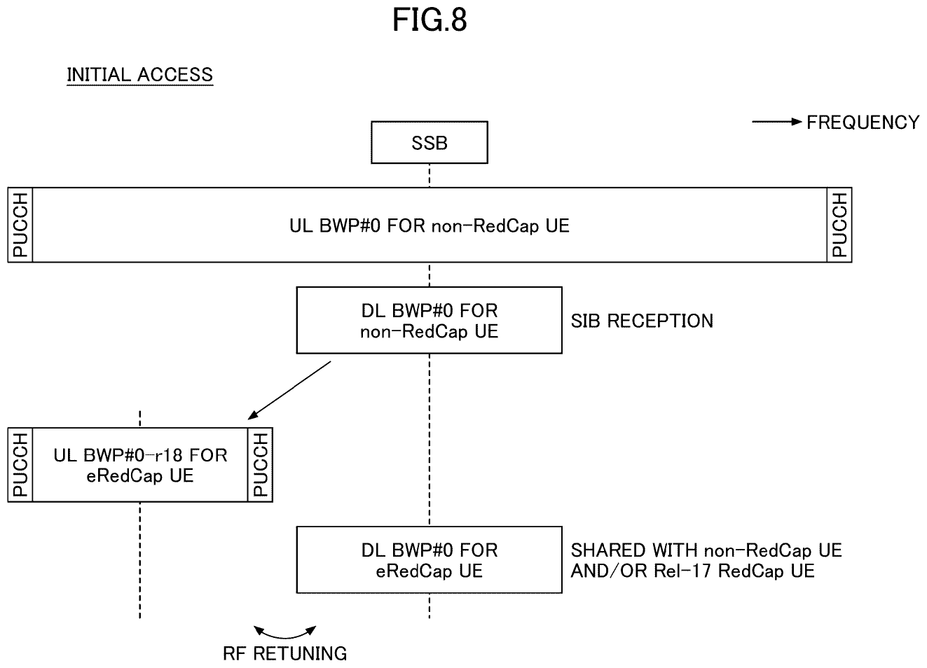

FIG. 8 is a second drawing illustrating an example of an operation of an eRedCap UE related to an embodiment of the present invention. FIG. 8 is an example in which UL-BWP #0-r18 is configured by SIB. As illustrated in FIG. 8, the terminal 20 receives SIB in DL-BWP #0 for the non-RedCap UE. UL-BWP #0-r18 that is different from UL-BWP #0 is configured by the SIB. DL-BWP #0 for the eRedCap UE is shared by the non-RedCap UE and/or the RedCap UE. In FIG. 8, the center frequencies of UL-BWP #0-r18 and DL-BWP #0 are different, and thus, the terminal 20 is required to perform RF retuning in a case where the terminal 20 performs switching between UL and DL. It is to be noted that the width, the position of the frequency domain, etc., of each BWP are mere examples, and UL-BWP #0-r18 may be arranged in the different frequency domain, for example.

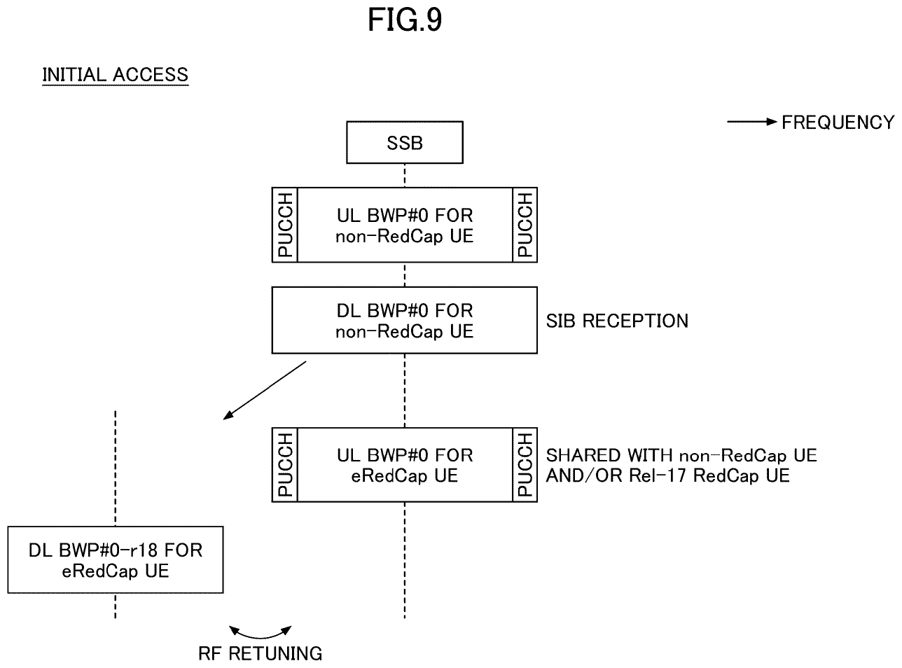

FIG. 9 is a third drawing illustrating an example of an operation of an eRedCap UE related to an embodiment of the present invention. FIG. 9 is an example in which DL-BWP #0-r18 is configured by SIB. As illustrated in FIG. 9, the terminal 20 receives SIB in DL-BWP #0 for the non-RedCap UE. DL-BWP #0-r18 that is different from DL-BWP #0 is configured by the SIB. UL-BWP #0 for the eRedCap UE is shared by the non-RedCap UE and/or the RedCap UE. In FIG. 9, the center frequencies of UL-BWP #0 and DL-BWP #0-r18 are different, and thus, the terminal 20 is required to perform RF retuning in a case where the terminal 20 performs switching between UL and DL. It is to be noted that the width, the position of the frequency domain, etc., of each BWP are mere examples, and DL-BWP #0-r18 may be arranged in the different frequency domain, for example.

In a case where UL-BWP #0-r18 is configured, the terminal 20 may perform UL transmission related to random access in this BWP. With respect to the UL-BWP #0-r18, the terminal 20 may expect that the configuration related to random access is to be indicated by the conventional SIB or by a new SIB. For example, the terminal 20 may expect that the configuration related to random access is to be indicated by “rach-ConfigCommon” included in “BWP-UplinkCommon”, may expect that the configuration related to random access is to be indicated by “PUSCH-ConfigCommon” included in “BWP-UplinkCommon”, or may expect that the configuration related to random access is to be indicated by “pucch-ConfigCommon” included in “BWP-UplinkCommon”.

In addition, in a case where UL-BWP #0-r18 is configured and CD-SSB is not included in this BWP, the terminal 20 may expect that the NCD-SSB reception in this BWP is to be newly specified or configured. The CD-SSB may be an SS/PBCH block for the terminal 20 to obtain SIB1. For example, the terminal 20 may expect that the reception of the NCD-SSB by using 20 PRBs at the lower end, the center, or the upper end of this BWP at a predetermined period (for example, 20 ms) is to be specified in the technical specifications. In addition, the terminal 20 may expect that the PRB position and the NCD-SSB periodicity of the NCD-SSB transmission in this BWP is to be configured by the base station 10.

In a case where DL-BWP #0-r18 is configured, the terminal 20 may perform DL reception related to random access in this BWP. With respect to this BWP, the terminal 20 may expect that the configuration related to random access is to be indicated by the conventional SIB or by a new SIB. For example, the terminal 20 may expect that the configuration related to random access is to be indicated by “pdsch-ConfigCommon” included in “BWP-DownlinkCommon”, or may expect that the configuration related to random access is to be indicated by “pdcch-ConfigCommon” included in “BWP-DownlinkCommon”.

In addition, the terminal 20 may expect that an information element “controlResourceSetZero” included in “pdcch-ConfigCommon” is to be a parameter of CORESET #0 for configuring CSS or USS (UE-specific search space) and the information element is to be configured in DL-BWP #0-r18 or is to be configured in DL-BWP #0 for the eRedCap UE.

In addition, the terminal 20 may expect that an information element “searchSpaceZero” included in “pdcch-ConfigCommon” is to be a parameter for configuring CSS #0 and the information element is to be configured in DL-BWP #0-r18 or is to be configured in DL-BWP #0 for the eRedCap UE.

In a case where CD-SSB is not included in DL-BWP #0-r18, the terminal 20 may expect that the NCD-SSB reception in this BWP is to be newly specified or configured. For example, the terminal 20 may expect that the reception of the SSB by using 20 PRBs at the lower end, the center, or the upper end of this BWP at a predetermined period (for example, 20 ms) is to be specified in the technical specifications. In addition, the terminal 20 may expect that the PRB position and the NCD-SSB periodicity of the NCD-SSB transmission in DL-BWP #0-r18 is to be configured by the base station 10.

In a case where DL-BWP #0-r18 and/or UL-BWP #0-r18 are/is configured, the terminal 20 may determine that this (these) BWP(s) is/are to be an active BWP(s) in the connected mode. In a case where this BWP (that is, ID=0) is configured by “firstActiveDownlinkBWP-Id” or “firstActiveUplinkBWP-Id”, the terminal 20 may determine that this BWP is to be an active BWP in the connected mode. In addition, the terminal 20 may determine that this BWP is to be an active BWP in the connected mode regardless of the configuration of “firstActiveDownlinkBWP-Id” or “firstActive UplinkBWP-Id”.

In a case where CD-SSB is not included in DL-BWP #0-r18, the terminal 20 may expect that the NCD-SSB reception in the DL-BWP #0-r18 is to be newly specified or configured. For example, the terminal 20 may expect that the reception of the SSB by using 20 PRBs at the lower end, the center, or the upper end of this DL-BWP at a predetermined period (for example, 20 ms) is to be specified in the technical specifications. In addition, the terminal 20 may expect that the PRB position and the NCD-SSB periodicity of the NCD-SSB transmission in DL-BWP #0-r18 is to be configured by the base station 10.

The terminal 20 may expect that the expectation related to the NCD-SSB reception is different in accordance with the terminal capability. For example, the terminal 20 may expect that the terminal capability for not supporting the NCD-SSB reception in DL-BWP #0-r18 is to be specified, or may expect that the terminal capability for supporting the NCD-SSB reception in DL-BWP #0-r18 is to be specified.

In a case where DL-BWP #0-r18 is configured, the terminal 20 may perform paging reception in this BWP. The terminal 20 may expect that the configuration related to the paging reception is to be indicated by the conventional SIB or by a new SIB with respect to this BWP.

For example, the terminal 20 may expect that the configuration related to the paging is to be indicated by “pdsch-ConfigCommon” included in “BWP-DownlinkCommon”, or may expect that the configuration related to the paging is to be indicated by “pdcch-ConfigCommon” included in “BWP-DownlinkCommon”.

In addition, the terminal 20 may expect that an information element “controlResourceSetZero” included in “pdcch-ConfigCommon” is to be a parameter of CORESET #0 for configuring CSS or USS and the information element is to be configured in DL-BWP #0-r18 or is to be configured in DL-BWP #0 for the eRedCap UE.

In addition, the terminal 20 may expect that an information element “searchSpaceZero” included in “pdcch-ConfigCommon” is to be a parameter for configuring CSS #0 and the information element is to be configured in DL-BWP #0-r18 or is to be configured in DL-BWP #0 for the eRedCap UE.

In addition, the terminal 20 may expect that the configuration related to paging in DL-BWP #0-r18 is to be indicated by an information element “firstPDCCH-MonitoringOccasionOfPO” included in “pdcch-ConfigCommon”. In addition, the terminal 20 may expect that the search space ID for paging reception in DL-BWP #0-r18 is to be indicated by an information element “pagingSearchSpace” included in “pdcch-ConfigCommon”.

In addition, the terminal 20 may expect that the parameters described in 1) to 4) below may be indicated by the conventional SIB1 or by a newly defined SIB.

### 1) “Ns”

2) “nAndPagingFrameOffset”
3) “nrofPDCCH-MonitoringOccasionPerSSB-InPO”
4) Default DRX cycle length

In a case where CD-SSB is not included in DL-BWP #0-r18, the terminal 20 may expect that the NCD-SSB reception in this DL-BWP #0-r18 is to be newly specified or configured. For example, the terminal 20 may expect that the reception of the SSB by using 20 PRBs at the lower end, the center, or the upper end of this DL-BWP at a predetermined period (for example, 20 ms) is to be specified in the technical specifications. In addition, the PRB position and the NCD-SSB periodicity of the NCD-SSB transmission in DL-BWP #0-r18 may be configured from the network to the terminal 20.

In a case where DL-BWP #0-r18 is configured, the terminal 20 may perform SIB reception in this BWP. The terminal 20 may expect that the configuration related to the SIB reception is to be indicated by the conventional SIB or by a new SIB with respect to this BWP. For example, the terminal 20 may expect that the configuration related to the SIB is to be indicated by “pdsch-ConfigCommon” included in “BWP-DownlinkCommon”, or may expect that the configuration related to the SIB is to be indicated by “pdcch-ConfigCommon” included in “BWP-DownlinkCommon”.

In addition, the terminal 20 may expect that an information element “controlResourceSetZero” included in “pdcch-ConfigCommon” is to be a parameter of CORESET #0 for configuring CSS or USS and the information element is to be configured in DL-BWP #0-r18 or is to be configured in DL-BWP #0 for the eRedCap UE.

In addition, the terminal 20 may expect that an information element “searchSpaceZero” included in “pdcch-ConfigCommon” is to be a parameter for configuring CSS #0 and the information element is to be configured in DL-BWP #0-r18 or is to be configured in DL-BWP #0 for the eRedCap UE.

In addition, the terminal 20 may expect that the configuration related to acquisition of SIB2 system information and the subsequent system information in DL-BWP #0-r18 is to be indicated an by information element “searchSpaceOtherSystemInformation” included in “pdcch-ConfigCommon”, or may expect that the search space ID for SIB1 reception in DL-BWP #0-r18 is to be indicated by an information element “searchSpaceSIB1” included in “pdcch-ConfigCommon”.

In a case where CD-SSB is not included in DL-BWP #0-r18, the terminal 20 may expect that the NCD-SSB reception in this DL-BWP #0-r18 is to be newly specified or configured. For example, the terminal 20 may receive NCD-SSB in 20 PRBs at the lower end, the center, or the upper end of this DL-BWP with a predetermined periodicity (for example, 20 ms). In addition, the terminal 20 may expect that the PRB position and the NCD-SSB periodicity of the NCD-SSB transmission in DL-BWP #0-r18 is to be configured by the base station 10.

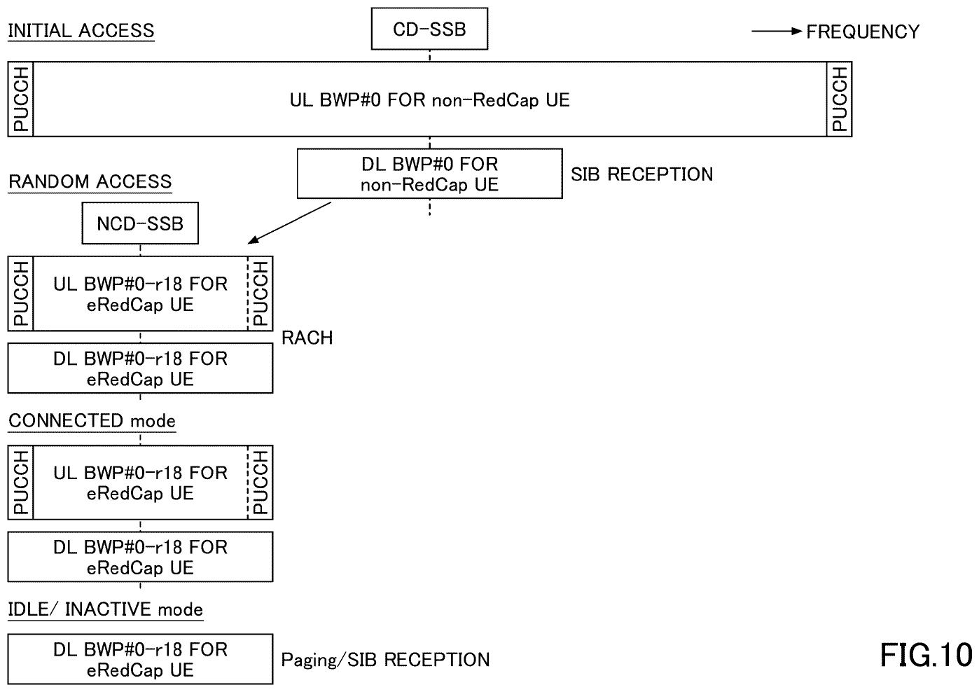

FIG. 10 is a first drawing illustrating an example of an overall operation of an eRedCap UE related to an embodiment of the present invention. FIG. 10 is an example in which DL-BWP #0-r18 and UL-BWP #0-r18 are configured by SIB. As illustrated in FIG. 10, the terminal 20 receives SIB in DL-BWP #0 for the non-RedCap UE. DL-BWP #0-r18 that is different from DL-BWP #0 and UL-BWP #0-r18 that is different from UL-BWP #0 are configured by the SIB.

In the random access, the terminal 20 may transmit Msg.1/3/A and HARQ-ACK corresponding to Msg.4/B in UL-BWP #0-r18 and may receive Msg.2/4/B and an SSB in DL-BWP #0-r18. In the connected mode, the terminal 20 may transmit a reference signal/control signal and data in UL-BWP #0-r18 and may receive an SSB/reference signal/control signal and data in DL-BWP #0-r18. In the idle/inactive mode, the terminal 20 receives an SSB/paging and SIB in DL-BWP #0-r18.

According to an operation as described above, the center frequencies of BWPs for the eRedCap UE can be aligned. It is to be noted that the width, the position of the frequency domain, etc., of each BWP are mere examples, and DL-BWP #0-r18 and UL-BWP #0-r18 may be arranged in the different frequency domain, for example.

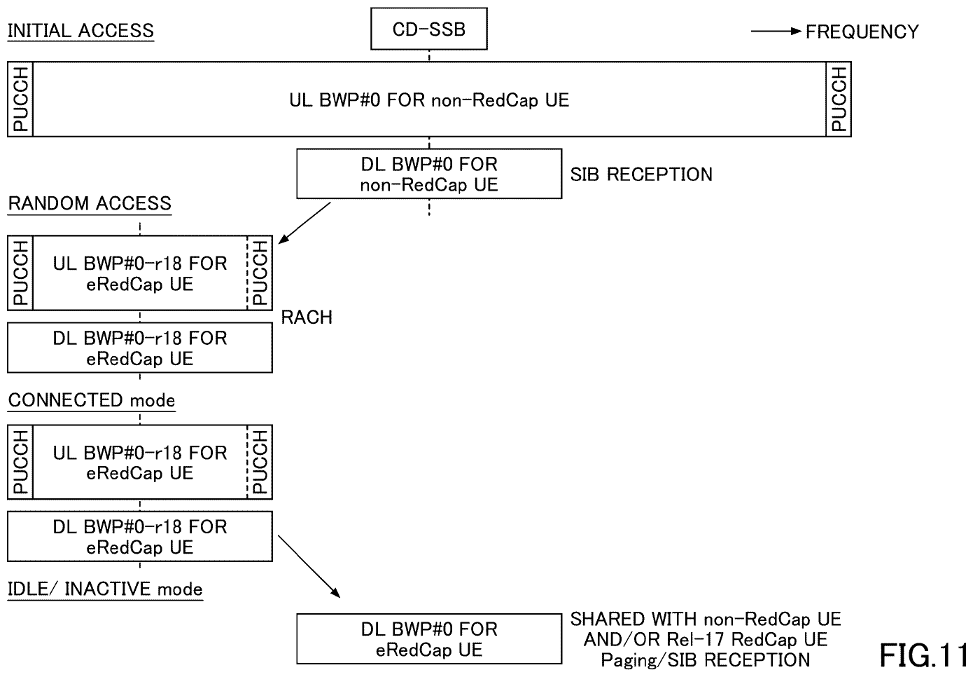

FIG. 11 is a second drawing illustrating an example of an overall operation of an eRedCap UE related to an embodiment of the present invention. FIG. 11 is an example in which DL-BWP #0-r18 and UL-BWP #0-r18 are configured by SIB. As illustrated in FIG. 11, the terminal 20 receives SIB in DL-BWP #0 for the non-RedCap UE. DL-BWP #0-r18 that is different from DL-BWP #0 and UL-BWP #0-r18 that is different from UL-BWP #0 are configured by the SIB.

In the random access, the terminal 20 may transmit Msg.1/3/A and HARQ-ACK corresponding to Msg.4/B in UL-BWP #0-r18 and may receive Msg. 2/4/B in DL-BWP #0-r18. In addition, in a case where SSB reception is needed (for example, the reception periodicity is defined/configured), the terminal 20 may perform SSB reception in DL-BWP #0 for the eRedCap UE by performing RF re-tuning. Msg.2/4/B may be received in DL-BWP #0-r18 by performing RF re-tuning after the SSB reception. In the connected mode, the terminal 20 may transmit a reference signal/control signal and data in UL-BWP #0-r18 and may receive a reference signal/control signal and data in DL-BWP #0-r18. In addition, in a case where SSB reception is needed (for example, the reception periodicity is defined/configured), the terminal 20 may perform SSB reception in DL-BWP #0 for the eRedCap UE by performing RF re-tuning. The terminal 20 may receive a reference signal/control signal and data in DL-BWP #0-r18 by performing RF re-tuning after the SSB reception.

In the idle/inactive mode, the terminal 20 receives an SSB/paging and SIB in DL-BWP #0 for the eRedCap UE. DL-BWP #0 for the eRedCap UE is shared by the non-RedCap UE and/or the RedCap UE.

According to an operation as described above, the center frequencies of BWPs for the eRedCap UE can be aligned. In addition, the SSB can be shared with the non-RedCap UE and/or the RedCap UE without requiring an additional SSB for receiving paging and SIB at the time of an idle/inactive mode. It is to be noted that the width, the position of the frequency domain, etc., of each BWP are mere examples, and DL-BWP #0-r18 and UL-BWP #0-r18 may be arranged in the different frequency domain, for example.

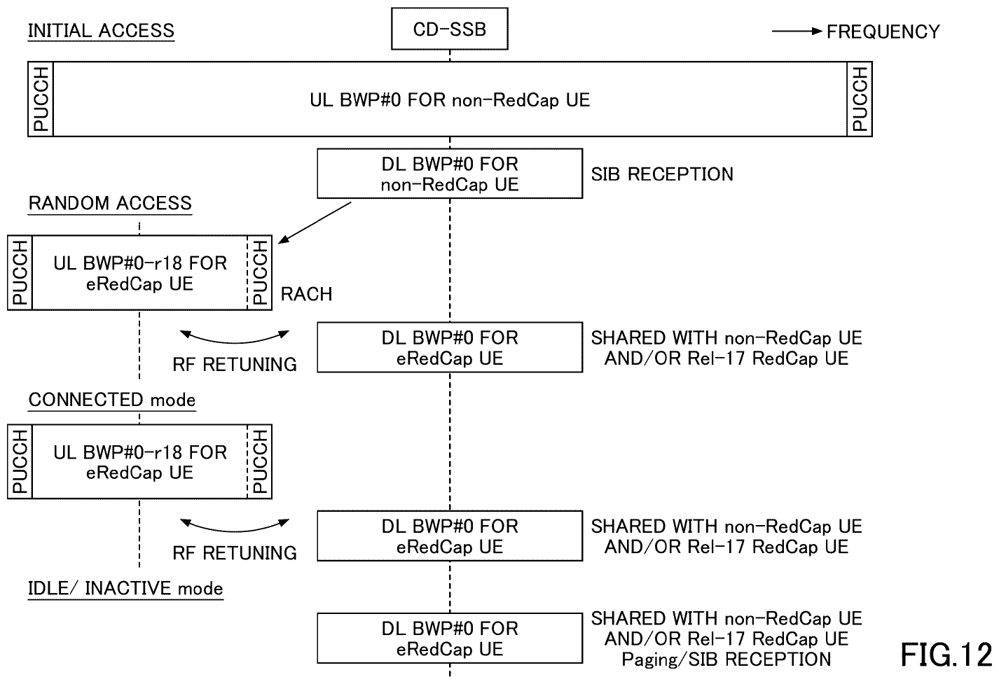

FIG. 12 is a third drawing illustrating an example of an operation of an eRedCap UE related to an embodiment of the present invention. FIG. 12 is an example in which UL-BWP #0-r18 is configured by SIB. As illustrated in FIG. 12, the terminal 20 receives SIB in DL-BWP #0 for the non-RedCap UE. UL-BWP #0-r18 that is different from UL-BWP #0 is configured by the SIB.

In the random access, the terminal 20 may transmit Msg.1/3/A and HARQ-ACK corresponding to Msg.4/B in UL-BWP #0-r18 and may receive Msg.2/4/B and an SSB in DL-BWP #0 for the eRedCap UE. DL-BWP #0 for the eRedCap UE is shared by the non-RedCap UE and/or the RedCap UE. In the random access, the terminal 20 is required to perform RF retuning in a case where the terminal 20 performs switching between UL and DL.

In the connected mode, the terminal 20 may transmit a reference signal/control signal and data in UL-BWP #0-r18 and may receive an SSB/reference signal/control signal and data in DL-BWP #0 for the eRedCap UE. DL-BWP #0 for the eRedCap UE is shared by the non-RedCap UE and/or the RedCap UE. In the connected mode, the terminal 20 is required to perform RF retuning in a case where the terminal 20 performs switching between UL and DL.

In the idle/inactive mode, the terminal 20 receives an SSB/paging and SIB in DL-BWP #0 for the eRedCap UE. DL-BWP #0 for the eRedCap UE is shared by the non-RedCap UE and/or the RedCap UE.

According to an operation as described above, the SSB can be shared with the non-RedCap UE and/or the RedCap UE without requiring an additional SSB for receiving paging and SIB at the time of an idle/inactive mode. It is to be noted that the width, the position of the frequency domain, etc., of each BWP are mere examples, and UL-BWP #0-r18 may be arranged in the different frequency domain, for example.

It is to be noted that the definition of the RedCap UE may be one of 1) to 3) below, or may be a different definition.

1) UE that has indicated that the UE itself is a RedCap UE to the network via one of Msg.1/3/A. For example, the Msg.1/A may be transmitted using a resource that is defined or configured for the RedCap UE, or an indication field in Msg3 that is defined or configured for the RedCap UE may be used for indicating that the UE itself is a Red Cap UE.
2) UE that supports a specific UE capability. For example, the specific UE capability may be a UE capability of supporting up to 20 MHz bandwidth in FR1 and up to 100 MHz bandwidth in FR2. In addition, the specific UE capability may be a UE capability of supporting one or two reception branches and may be UE capability of supporting the maximum number of DL-MIMO layers corresponding to the supported number of reception branches. In addition, the specific UE capability may be a UL capability of supporting one of FD-FDD (Full Duplex-Frequency Division Duplex) operation or Type A HD-FDD (Half Duplex-Frequency Division Duplex) operation in the FR1 FDD bands. In addition, the specific UE capability may be a UE capability of supporting one of DL up to 64 QAM (Quadrature amplitude modulation) or DL up to 256 QAM in FR1. In addition, the specific UE capability may be a UE capability of not supporting CA and/or DC.
3) UE that has reported to support the specific UE capability described in the above-described 2) to the network.

In addition, the definition of the eRedCap UE may be one of 1) to 3) below, or may be a different definition.

1) UE that has indicated that the UE itself is an eRedCap UE to the network via one of Msg.1/3/A. For example, the Msg.1/A may be transmitted using a resource that is defined or configured for the eRedCap UE, or an indication field in Msg3 that is defined or configured for the eRedCap UE may be used for indicating that the UE itself is an eRedCap UE.
2) UE that supports a specific UE capability. For example, the specific UE capability may be a UE capability of supporting up to 5 MHz bandwidth in FR1. In addition, the specific UE capability may be a UE capability of supporting the relaxed UE processing timeline for PDSCH and/or PUSCH and/or CSI. In addition, the specific UE capability may be a UE capability of supporting the reduced UE peak data rate in FR1. In addition, the specific UE capability may be a UE capability of supporting one or two reception branches and may be a UE capability of supporting the maximum number of DL-MIMO layers corresponding to the supported number of reception branches. In addition, the specific UE capability may be a UE capability of supporting one of FD-FDD (Full Duplex-Frequency Division Duplex) operation or Type A HD-FDD (Half Duplex-Frequency Division Duplex) operation in the FR1 FDD bands. In addition, the specific UE capability may be a UE capability of supporting one of DL up to 64 QAM (Quadrature amplitude modulation) or DL up to 256 QAM in FR1. In addition, the specific UE capability may be a UE capability of not supporting CA and/or DC.
3) UE that has reported to support the specific UE capability described in the above-described 2) to the network.

In addition, the terminal 20 may report the UE capability indicating whether or not to support the functions described in each of the above-described embodiments. For example, the terminal 20 may report the UE capability indicating whether or not to support a function of using an initial DL/UL-BWP that is different from that for the non-RedCap UE or the RedCap UE. In addition, the UE that has reported to support the function may be an eRedCap UE, or an eRedCap UE optionally supports the function.

In addition, the definition of the non-RedCap UE may be a UE that does not correspond to the definition of the RedCap UE or the definition of the eRedCap UE, may be a UE that supports a function that is supported as a mandatory function by a normal UE, or may be a UE that supports a bandwidth exceeding the maximum bandwidth supported by the RedCap UE.

According to the above-described embodiment, the terminal 20 can use DL-BWP that is different from DL-BWP for the non-RedCap UE or the RedCap UE and/or UL-BWP that is different from UL-BWP for the non-RedCap UE or the RedCap UE depending on the necessity. In addition, the terminal 20 can share DL-BWP for the non-RedCap UE or the RedCap UE and/or UL-BWP for the non-RedCap UE or the RedCap UE depending on the necessity.

In other words, the frequency band that is to be used by a terminal with reduced functions can be determined in the wireless communication system.

### Device Configuration

Next, a functional configuration example of the base station 10 and the terminal 20 for performing the processes and operations described above will be described.

### Base Station 10

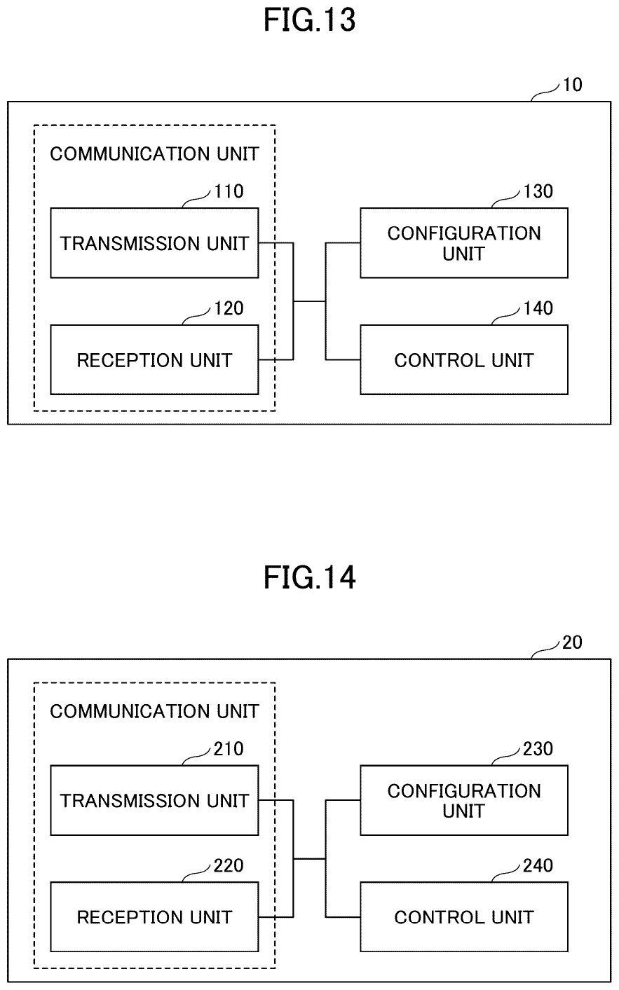

FIG. 13 is a diagram illustrating an example of a functional configuration of the base station 10. As shown in FIG. 13, the base station 10 includes a transmission unit 110, a reception unit 120, a configuration unit 130, and a control unit 140. The functional configuration illustrated in FIG. 13 is merely an example. Functional divisions and names of functional units may be anything as long as operations according to an embodiment of the present invention can be performed. Further, the transmission unit 110 and the reception unit 120 may be combined and may be referred to as a communication unit.

The transmission unit 110 includes a function for generating a signal to be transmitted to the terminal 20 side and transmitting the signal wirelessly. The reception unit 120 includes a function for receiving various signals transmitted from the terminal 20 and acquiring, for example, information of a higher layer from the received signals. Further, the transmission unit 110 has a function to transmit NR-PSS, NR-SSS, NR-PBCH, DL/UL control signals, DCI via PDCCH, data via PDSCH, and the like, to the terminal 20.

The configuration unit 130 stores preset configuration information and various configuration information items to be transmitted to the terminal 20 in a storage device included in the configuration unit 130 and reads the preset configuration information from the storage apparatus if necessary.

The control unit 140 performs scheduling of the terminal 20 for DL reception or UL transmission, via the transmission unit 110. In addition, the control unit 140 includes a function of performing LBT. The functional units related to signal transmission in the control unit 140 may be included in the transmission unit 110, and the functional units related to signal reception in the control unit 140 may be included in the reception unit 120. Further, the transmission unit 110 may be referred to as a transmitter, and the reception unit 120 may be referred to as a receiver.

### Terminal 20

FIG. 14 is a diagram illustrating an example of a functional configuration of the terminal 20. As shown in FIG. 14, the terminal 20 includes a transmission unit 210, a reception unit 220, a configuration unit 230, and a control unit 240. The functional configuration illustrated in FIG. 14 is merely an example. Functional divisions and names of functional units may be anything as long as operations according to an embodiment of the present invention can be performed. the transmission unit 210 and the reception unit 220 may be combined and may be referred to as a communication unit.

The transmission unit 210 generates a transmission signal from transmission data and transmits the transmission signal wirelessly. The reception unit 220 receives various signals wirelessly and obtains upper layer signals from the received physical layer signals. In addition, the reception unit 220 has a function of receiving NR-PSS, NR-SSS, NR-PBCH, DL/UL/SL control signals, DCI via PDCCH, data via PDSCH, etc., transmitted from the base station 10. In addition, for example, with respect to the D2D communications, the transmission unit 210 may transmit, to another terminal 20, PSCCH (Physical Sidelink Control Channel), PSSCH (Physical Sidelink Shared Channel), PSDCH (Physical Sidelink Discovery Channel), PSBCH (Physical Sidelink Broadcast Channel), etc., and the reception unit 120 may receive, from the another terminal 20, PSCCH, PSSCH, PSDCH, or PSBCH.

The configuration unit 230 stores various configuration information items received from the base station 10 or the another terminal by the reception unit 220 in the storage device included in the configuration unit 230, and reads them from the storage device as necessary. In addition, the configuration unit 230 also stores pre-configured configuration information. The control unit 240 controls the terminal 20. In addition, the control unit 240 includes a function of performing LBT.

A terminal according to an embodiment of the present invention may be configured as a terminal described in each item below. In addition, a communication method below may be performed.

### Configuration Related to an Embodiment of the Present Invention

### First Item

A terminal including:
a communication unit configured to receive system information; and
a control unit configured to assume, based on the system information, that at least one of a downlink bandwidth part for a non-reduced function terminal that is different from that for a first function-reduced terminal; or an uplink bandwidth part for the non-reduced function terminal that is different from that for the first function-reduced terminal, is to be configured, wherein
a second function that is different from a first function for the first function-reduced terminal is reduced in the terminal.

### Second Item

The terminal as described in the first item, wherein
the communication unit performs at least one of transmission or reception related to a random access; transmission or reception in a connected mode; or paging reception and system information reception, by using the configured downlink bandwidth part or the configured uplink bandwidth part.

### Third Item

The terminal as described in the first item or the second item, wherein
the control unit assumes that a center frequency of the downlink bandwidth part is equal to a center frequency of the uplink bandwidth part in a case where the downlink bandwidth part and the uplink bandwidth part are configured.

### Fourth Item

The terminal as described in any one of the first item to the third item, wherein
the control unit assumes that the configured downlink bandwidth part or the configured uplink bandwidth part is to be an active bandwidth part in a

### Fifth Item

A base station including:
a transmission unit configured to transmit system information to a terminal; and
a control unit configured to configure, based on the system information, to the terminal, at least one of a downlink bandwidth part for a non-reduced function terminal that is different from that for a first function-reduced terminal; or an uplink bandwidth part for the non-reduced function terminal that is different from that for the first function-reduced terminal, wherein
a second function that is different from a first function for the first function-reduced terminal is reduced in the terminal.

### Sixth Item

A communication method performed by a terminal including:
a communication unit configured to receive system information; and
a control unit configured to assume, based on the system information, that at least one of a downlink bandwidth part for a non-reduced function terminal that is different from that for a first function-reduced terminal; or an uplink bandwidth part for the non-reduced function terminal that is different from that for the first function-reduced terminal, is to be configured, wherein
a second function that is different from a first function for the first function-reduced terminal is reduced in the terminal.

According to any one of the above-described configurations, a technique is provided that enables determination of the frequency band used by the function-reduced terminal in the wireless communication system. According to the first item, at least one of: a downlink bandwidth part for a non-reduced function terminal that is different from that for a first function-reduced terminal; or an uplink bandwidth part for the non-reduced function terminal that is different from that for the first function-reduced terminal, is expected to be configured. According to the second item, at least one of: transmission or reception related to a random access; transmission or reception in a connected mode; or paging reception and system information reception, by using the configured downlink bandwidth part or the configured uplink bandwidth part can be performed. According to the third item, a center frequency of the downlink bandwidth part can be expected to be equal to a center frequency of the uplink bandwidth part in a case where the downlink bandwidth part and the uplink bandwidth part are configured. According to the fourth item, the configured downlink bandwidth part or the configured uplink bandwidth part can be expected to be an active bandwidth part in the connected mode.

### Hardware Structure

In the above block diagrams used for describing an embodiment of the present invention (FIG. 13 and FIG. 14), functional unit blocks are shown. The functional blocks (function units) are realized by a freely-selected combination of hardware and/or software. Further, realizing means of each functional block is not limited in particular. In other words, each functional block may be realized by a single apparatus in which multiple elements are coupled physically and/or logically, or may be realized by two or more apparatuses that are physically and/or logically separated and are physically and/or logically connected (e.g., wired and/or wireless). The functional blocks may be realized by combining the above-described one or more apparatuses with software.

Functions include, but are not limited to, judging, determining, calculating, processing, deriving, investigating, searching, checking, receiving, transmitting, outputting, accessing, resolving, selecting, establishing, comparing, assuming, expecting, and deeming; broadcasting, notifying, communicating, forwarding, configuring, reconfiguring, allocating, mapping, and assigning, etc. For example, a functional block (component) that functions to transmit is called a transmitting unit or a transmitter. In either case, as described above, the implementation method is not particularly limited.

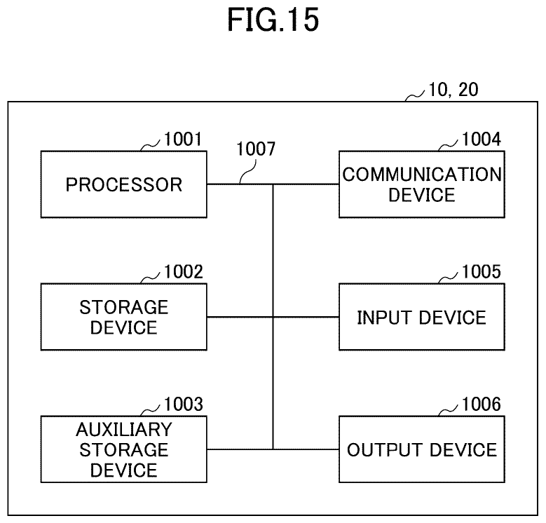

For example, the base station 10, the terminal 20, etc., according to an embodiment of the present disclosure may function as a computer for processing the radio communication method of the present disclosure. FIG. 15 is a drawing illustrating an example of hardware structures of the base station 10 and the terminal 20 according to an embodiment of the present invention. Each of the above-described base station 10 and the terminal 20 may be physically a computer device including a processor 1001, a storage device 1002, an auxiliary storage device 1003, a communication device 1004, an input device 1005, an output device 1006, a bus 1007, etc.

It should be noted that, in the descriptions below, the term “device” can be read as a circuit, a device, a unit, etc. The hardware structures of the base station 10 and the terminal 20 may include one or more of each of the devices illustrated in the figure, or may not include some devices.

Each function in the base station 10 and the terminal 20 is realized by having the processor 1001 perform an operation by reading predetermined software (programs) onto hardware such as the processor 1001 and the storage device 1002, and by controlling communication by the communication device 1004 and controlling at least one of reading and writing of data in the storage device 1002 and the auxiliary storage device 1003.

The processor 1001 controls the entire computer by, for example, controlling the operating system. The processor 1001 may include a central processing unit (CPU) including an interface with a peripheral apparatus, a control apparatus, a calculation apparatus, a register, etc. For example, the above-described control unit 140, control unit 240, and the like, may be implemented by the processor 1001.

Further, the processor 1001 reads out onto the storage device 1002 a program (program code), a software module, or data from the auxiliary storage device 1003 and/or the communication device 1004, and performs various processes according to the program, the software module, or the data. As the program, a program is used that causes the computer to perform at least a part of operations according to an embodiment of the present invention described above. For example, the control unit 140 of the base station 10 illustrated in FIG. 13 may be realized by control programs that are stored in the storage device 1002 and are executed by the processor 1001. Further, for example, the control unit 240 of the terminal 20 illustrated in FIG. 14 may be realized by control programs that are stored in the storage device 1002 and are executed by the processor 1001. The various processes have been described to be performed by a single processor 1001. However, the processes may be performed by two or more processors 1001 simultaneously or sequentially. The processor 1001 may be implemented by one or more chips. It should be noted that the program may be transmitted from a network via a telecommunication line.

The storage device 1002 is a computer-readable recording medium, and may include at least one of a ROM (Read Only Memory), an EPROM (Erasable Programmable ROM), an EEPROM (Electrically Erasable Programmable ROM), a RAM (Random Access Memory), etc. The storage device 1002 may be referred to as a register, a cache, a main memory, etc. The storage device 1002 is capable of storing programs (program codes), software modules, or the like, that are executable for performing communication processes according to an embodiment of the present invention.

The auxiliary storage device 1003 is a computer-readable recording medium, and may include at least one of, for example, an optical disk such as a CD-ROM (Compact Disc ROM), a hard disk drive, a flexible disk, a magneto optical disk (e.g., compact disc, digital versatile disc, Blu-ray (registered trademark) disk), a smart card, a flash memory (e.g., card, stick, key drive), a floppy (registered trademark) disk, a magnetic strip, etc. The above recording medium may be a database including the storage device 1002 and/or the auxiliary storage device 1003, a server, or any other appropriate medium.

The communication device 1004 is hardware (transmission or reception device) for communicating with computers via at least one of a wired network or a wireless network, and may be referred to as a network device, a network controller, a network card, a communication module, etc. The communication device 1004 may comprise a high frequency switch, duplexer, filter, frequency synthesizer, or the like, for example, to implement at least one of a frequency division duplex (FDD) or a time division duplex (TDD). For example, the transmitting/receiving antenna, the amplifier unit, the transmitting/receiving unit, the transmission line interface, and the like, may be implemented by the communication device 1004. The transmitting/receiving unit may be physically or logically divided into a transmitting unit and a receiving unit.

The input device 1005 is an input device that receives an external input (e.g., keyboard, mouse, microphone, switch, button, sensor). The output device 1006 is an output device that outputs something to the outside (e.g., display, speaker, LED lamp). It should be noted that the input device 1005 and the output device 1006 may be integrated into a single device (e.g., touch panel).

Further, the apparatuses including the processor 1001, the storage device 1002, etc., are connected to each other via the bus 1007 used for communicating information. The bus 1007 may include a single bus, or may include different buses between the apparatuses.

Further, each of the base station 10 and terminal 20 may include hardware such as a microprocessor, a digital signal processor (DSP), an ASIC (Application Specific Integrated Circuit), a PLD (Programmable Logic Device), a FPGA (Field Programmable Gate Array), etc., and a part or all of each functional block may be realized by the hardware. For example, the processor 1001 may be implemented by at least one of the above hardware elements.

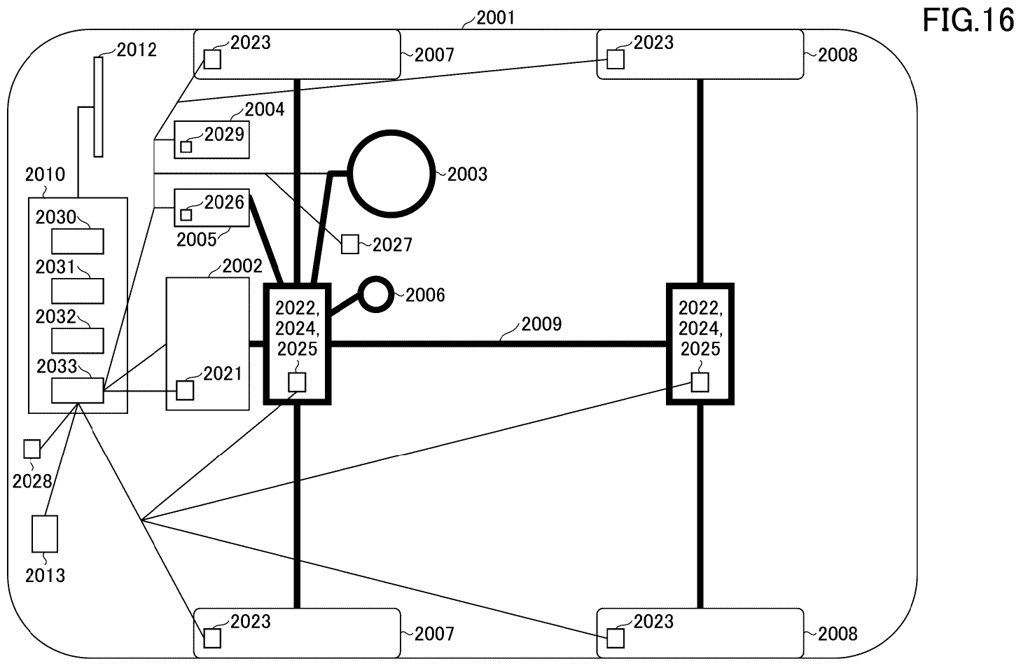

FIG. 16 shows an example of a configuration of a vehicle 2001. As shown in FIG. 16, the vehicle 2001 includes a drive unit 2002, a steering unit 2003, an accelerator pedal 2004, a brake pedal 2005, a shift lever 2006, a front wheel 2007, a rear wheel 2008, an axle 2009, an electronic control unit 2010, various sensors 2021-2029, an information service unit 2012, and a communication module 2013. The aspects/embodiments described in the present disclosure may be applied to a communication device mounted in the vehicle 2001, and may be applied to, for example, the communication module 2013.

The drive unit 2002 may include, for example, an engine, a motor, and a hybrid of an engine and a motor. The steering unit 2003 includes at least a steering wheel and is configured to steer at least one of the front wheel and the rear wheel, based on the operation of the steering wheel operated by the user.

The electronic control unit 2010 includes a microprocessor 2031, a memory (ROM, RAM) 2032, and a communication port (IO port) 2033. The electronic control unit 2010 receives signals from the various sensors 2021-2029 provided in the vehicle 2001. The electronic control unit 2010 may be referred to as an ECU (Electronic control unit).

The signals from the various sensors 2021 to 2029 include a current signal from a current sensor 2021 which senses the current of the motor, a front or rear wheel rotation signal acquired by a revolution sensor 2022, a front or rear wheel pneumatic signal acquired by a pneumatic sensor 2023, a vehicle speed signal acquired by a vehicle speed sensor 2024, an acceleration signal acquired by an acceleration sensor 2025, a stepped-on accelerator pedal signal acquired by an accelerator pedal sensor 2029, a stepped-on brake pedal signal acquired by a brake pedal sensor 2026, an operation signal of a shift lever acquired by a shift lever sensor 2027, and a detection signal, acquired by an object detection sensor 2028, for detecting an obstacle, a vehicle, a pedestrian, and the like.

The information service unit 2012 includes various devices for providing (outputting) various kinds of information such as driving information, traffic information, and entertainment information, including a car navigation system, an audio system, a speaker, a television, and a radio, and one or more ECUs controlling these devices. The information service unit 2012 provides various types of multimedia information and multimedia services to the occupants of the vehicle 2001 by using information obtained from the external device through the communication module 2013 or the like.

The information service unit 2012 may include an input device (e.g., a keyboard, mouse, microphone, switch, button, sensor, touch panel, etc.) that accepts an external input, or may include an output device (e.g., a display, speaker, LED lamp, touch panel, etc.) that implements an external output.

A driving support system unit 2030 includes: various devices for providing functions of preventing accidents and reducing a driver's operating burden such as a millimeter wave radar, a LiDAR (Light Detection and Ranging), a camera, a positioning locator (e.g., GNSS, etc.), map information (e.g., high definition (HD) map, autonomous vehicle (AV) map, etc.), a gyro system (e.g., IMU (Inertial Measurement Unit), INS (Inertial Navigation System), etc.), an AI (Artificial Intelligence) chip, an AI processor; and one or more ECUs controlling these devices. In addition, the driving support system unit 2030 transmits and receives various types of information via the communication module 2013 to realize a driving support function or an autonomous driving function.

The communication module 2013 may communicate with the microprocessor 2031 and components of the vehicle 2001 via a communication port. For example, the communication module 2013 transmits and receives data via a communication port 2033, to and from the drive unit 2002, the steering unit 2003, the accelerator pedal 2004, the brake pedal 2005, the shift lever 2006, the front wheel 2007, the rear wheel 2008, the axle 2009, the microprocessor 2031 and the memory (ROM, RAM) 2032 in the electronic control unit 2010, and sensors 2021 to 2029 provided in the vehicle 2001.

The communication module 2013 is a communication device that can be controlled by the microprocessor 2031 of the electronic control unit 2010 and that is capable of communicating with external devices. For example, various kinds of information are transmitted to and received from external devices through radio communication. The communication module 2013 may be internal to or external to the electronic control unit 2010. The external devices may include, for example, a base station, a mobile station, or the like.

The communication module 2013 may transmit, to an external device by using wireless communications, at least one of: a signal from the above-described various sensors 2021 to 2029 that is input to the electronic control unit 2010; information that is obtained based on the signal; or information based on an input obtained from outside (user) via the information service unit 2012. The electronic control unit 2010, the various sensors 2021 to 2029, the information service unit 2012, or the like, may be referred to as an input unit for receiving an input. For example, PUSCH transmitted by the communication module 2013 may include information based on the above-described input.

The communication module 2013 receives various types of information (traffic information, signal information, inter-vehicle information, etc.) transmitted from the external devices and displays the received information on the information service unit 2012 provided in the vehicle 2001. The information service unit 2012 may be referred to as an output unit for outputting information (for example, outputting information to devices such as a display or a speaker, based on PDSCH (or data/information decoded from the PDSCH) received by the communication module 2013).

In addition, the communication module 2013 stores the various types of information received from the external devices in the memory 2032 available to the microprocessor 2031. Based on the information stored in the memory 2032, the microprocessor 2031 may control the drive unit 2002, the steering unit 2003, the accelerator pedal 2004, the brake pedal 2005, the shift lever 2006, the front wheel 2007, the rear wheel 2008, the axle 2009, the sensors 2021-2029, etc., mounted in the vehicle 2001.

### Supplement of Embodiment

As described above, one or more embodiments have been described. The present invention is not limited to the above embodiments. A person skilled in the art should understand that there are various modifications, variations, alternatives, replacements, etc., of the embodiments. In order to facilitate understanding of the present invention, specific values have been used in the description. However, unless otherwise specified, those values are merely examples and other appropriate values may be used. The division of the described items may not be essential to the present invention. The things that have been described in two or more items may be used in a combination if necessary, and the thing that has been described in one item may be appropriately applied to another item (as long as there is no contradiction). Boundaries of functional units or processing units in the functional block diagrams do not necessarily correspond to the boundaries of physical parts. Operations of multiple functional units may be physically performed by a single part, or an operation of a single functional unit may be physically performed by multiple parts. The order of sequences and flowcharts described in an embodiment of the present invention may be changed as long as there is no contradiction. For the sake of description convenience, the base station 10 and the terminal 20 have been described by using functional block diagrams. However, the apparatuses may be realized by hardware, software, or a combination of hardware and software. The software executed by a processor included in the base station 10 according to an embodiment of the present invention and the software executed by a processor included in the terminal 20 according to an embodiment of the present invention may be stored in a random access memory (RAM), a flash memory, a read only memory (ROM), an EPROM, an EEPROM, a register, a hard disk (HDD), a removable disk, a CD-ROM, a database, a server, or any other appropriate recording medium.

Further, information indication may be performed not only by methods described in an aspect/embodiment of the present specification but also a method other than those described in an aspect/embodiment of the present specification. For example, the information indication may be performed by physical layer signaling (e.g., DCI (Downlink Control Information), UCI (Uplink Control Information)), upper layer signaling (e.g., RRC (Radio Resource Control) signaling, MAC (Medium Access Control) signaling, broadcast information (MIB (Master Information Block), SIB (System Information Block))), other signals, or combinations thereof. Further, RRC signaling may be referred to as an RRC message. The RRC signaling may be, for example, an RRC connection setup message, an RRC connection reconfiguration message, or the like.

Each aspect/embodiment described in the present disclosure may be applied to at least one of a system using LTE (Long Term Evolution), LTE-A (LTE-Advanced), SUPER 3G, IMT-Advanced, 4G (4th generation mobile communication system), 5G (5th generation mobile communication system), 6th generation mobile communication system (6G), xth generation mobile communication system (xG) (xG (x is, for example, an integer or a decimal)), FRA (Future Radio Access), NR (new Radio), New radio access (NX), Future generation radio access (FX), W-CDMA (registered trademark), GSM (registered trademark), CDMA2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), and other appropriate systems, and a next generation system enhanced, modified, developed, or defined therefrom. Further, multiple systems may also be applied in combination (e.g., at least one of LTE or LTE-A combined with 5G, etc.).

The order of processing steps, sequences, flowcharts or the like of an aspect/embodiment described in the present specification may be changed as long as there is no contradiction. For example, in a method described in the present specification, elements of various steps are presented in an exemplary order. The order is not limited to the presented specific order.

The particular operations, that are supposed to be performed by the base station 10 in the present specification, may be performed by an upper node in some cases. In a network including one or more network nodes including the base station 10, it is apparent that various operations performed for communicating with the terminal 20 may be performed by the base station 10 and/or another network node other than the base station 10 (for example, but not limited to, MME or S-GW). According to the above, a case is described in which there is a single network node other than the base station 10. However, a combination of multiple other network nodes may be considered (e.g., MME and S-GW).

The information or signals described in this disclosure may be output from a higher layer (or lower layer) to a lower layer (or higher layer). The information or signals may be input or output through multiple network nodes.

The input or output information may be stored in a specific location (e.g., memory) or managed using management tables. The input or output information may be overwritten, updated, or added. The information that has been output may be deleted. The information that has been input may be transmitted to another apparatus.

A decision or a determination in an embodiment of the present invention may be realized by a value (0 or 1) represented by one bit, by a boolean value (true or false), or by comparison of numerical values (e.g., comparison with a predetermined value).

Software should be broadly interpreted to mean, whether referred to as software, firmware, middle-ware, microcode, hardware description language, or any other name, instructions, instruction sets, codes, code segments, program codes, programs, subprograms, software modules, applications, software applications, software packages, routines, subroutines, objects, executable files, executable threads, procedures, functions, and the like.

Further, software, instructions, information, and the like may be transmitted and received via a transmission medium. For example, in the case where software is transmitted from a website, server, or other remote source using at least one of wired line technologies (such as coaxial cable, fiber optic cable, twisted pair, digital subscriber line (DSL), etc.) or wireless technologies (infrared, microwave, etc.), at least one of these wired line technologies or wireless technologies is included within the definition of the transmission medium.

Information, a signal, or the like, described in the present specification may be represented by using any one of various different technologies. For example, data, an instruction, a command, information, a signal, a bit, a symbol, a chip, or the like, described throughout the present application, may be represented by a voltage, an electric current, electromagnetic waves, magnetic fields, a magnetic particle, optical fields, a photon, or a combination thereof.

It should be noted that a term used in the present specification and/or a term required for understanding of the present specification may be replaced by a term having the same or similar meaning. For example, a channel and/or a symbol may be a signal (signaling). Further, a signal may be a message. Further, the component carrier (CC) may be referred to as a carrier frequency, cell, frequency carrier, or the like.

As used in the present disclosure, the terms “system” and “network” are used interchangeably.

Further, the information, parameters, and the like, described in the present disclosure may be expressed using absolute values, relative values from predetermined values, or they may be expressed using corresponding different information. For example, a radio resource may be what is indicated by an index.

The names used for the parameters described above are not used as limitations. Further, the mathematical equations using these parameters may differ from those explicitly disclosed in the present disclosure. Because the various channels (e.g., PUCCH, PDCCH) and information elements may be identified by any suitable names, the various names assigned to these various channels and information elements are not used as limitations.

In the present disclosure, the terms “BS: Base Station”, “Radio Base Station”, “Base Station”, “Fixed Station”, “NodeB”, “eNodeB (eNB)”, “gNodeB (gNB)”, “Access Point”, “Transmission Point”, “Reception Point”, “Transmission/Reception Point”, “Cell”, “Sector”, “Cell Group”, “Carrier”, “Component Carrier”, and the like, may be used interchangeably. The base station may be referred to as a macro-cell, a small cell, a femtocell, a picocell and the like.

The base station may accommodate (provide) one or more (e.g., three) cells. In the case where the base station accommodates a plurality of cells, the entire coverage area of the base station may be divided into a plurality of smaller areas, and each smaller area may provide communication services by means of a base station subsystem (e.g., an indoor small base station or a remote Radio Head (RRH)). The term “cell” or “sector” refers to a part or all of the coverage area of at least one of the base station and base station subsystem that provides communication services at the coverage.

In the present disclosure, a transmission of information from the base station to the terminal may be replaced with an indication of control or operation from the base station to the terminal based on the information.

In the present disclosure, terms such as “mobile station (MS)”, “user terminal”, “user equipment (UE)”, “terminal”, and the like, may be used interchangeably.

There is a case in which the mobile station may be referred to, by a person skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms.

At least one of the base station or the mobile station may be referred to as a transmission apparatus, reception apparatus, communication apparatus, or the like. The at least one of the base station or the mobile station may be a device mounted on the mobile station, the mobile station itself, or the like. The mobile station may be a vehicle (e.g., a car, an airplane, etc.), an unmanned mobile body (e.g., a drone, an automated vehicle, etc.), or a robot (manned or unmanned). At least one of the base station or the mobile station may include an apparatus that does not necessarily move during communication operations. For example, at least one of the base station or the mobile station may be an IoT (Internet of Things) device such as a sensor.

Further, the base station in the present disclosure may be read as the user terminal. For example, each aspect/embodiment of the present disclosure may be applied to a configuration in which communications between the base station and the user terminal are replaced by communications between multiple terminals 20 (e.g., may be referred to as D2D (Device-to-Device), V2X (Vehicle-to-Everything), etc.). In this case, the function of the base station 10 described above may be provided by the terminal 20. Further, the phrases “up” and “down” may also be replaced by the phrases corresponding to terminal-to-terminal communication (e.g., “side”). For example, an uplink channel, a downlink channel, or the like, may be read as a sidelink channel.

Further, the user terminal in the present disclosure may be read as the base station. In this case, the function of the user terminal described above may be provided by the base station.

The term “determining” used in the present specification may include various actions or operations. The terms “determination” and “decision” may include “determination” and “decision” made with judging, calculating, computing, processing, deriving, investigating, searching (looking up, search, inquiry) (e.g., search in a table, a database, or another data structure), or ascertaining. Further, the “determining” may include “determining” made with receiving (e.g., receiving information), transmitting (e.g., transmitting information), inputting, outputting, or accessing (e.g., accessing data in a memory). Further, the “determining” may include a case in which “resolving”, “selecting”, “choosing”, “establishing”, “comparing”, or the like is deemed as “determining”. In other words, the “determining” may include a case in which a certain action or operation is deemed as “determining”. Further, “decision” may be read as “assuming”, “expecting”, or “considering”, etc.

The term “connected” or “coupled” or any variation thereof means any direct or indirect connection or connection between two or more elements and may include the presence of one or more intermediate elements between the two elements “connected” or “coupled” with each other. The coupling or connection between the elements may be physical, logical, or a combination thereof. For example, “connection” may be read as “access”. As used in the present disclosure, the two elements may be thought of as being “connected” or “coupled” to each other using at least one of the one or more wires, cables, or printed electrical connections and, as a number of non-limiting and non-inclusive examples, electromagnetic energy having wavelengths in the radio frequency region, the microwave region, and the light (both visible and invisible) region.

The reference signal may be abbreviated as RS or may be referred to as a pilot, depending on the applied standards.

The description “based on” used in the present specification does not mean “based on only” unless otherwise specifically noted. In other words, the phrase “based on” means both “based on only” and “based on at least”.

Any reference to an element using terms such as “first” or “second” as used in the present disclosure does not generally limit the amount or the order of those elements. These terms may be used in the present disclosure as a convenient way to distinguish between two or more elements. Therefore, references to the first and second elements do not imply that only two elements may be employed or that the first element must in some way precede the second element. “Means” included in the configuration of each of the above apparatuses may be replaced by “parts”, “circuits”, “devices”, etc.

In the case where the terms “include”, “including” and variations thereof are used in the present disclosure, these terms are intended to be comprehensive in the same way as the term “comprising”. Further, the term “or” used in the present specification is not intended to be an “exclusive or”.

A radio frame may include one or more frames in the time domain. Each of the one or more frames in the time domain may be referred to as a subframe. The subframe may further include one or more slots in the time domain. The subframe may be a fixed length of time (e.g., 1 ms) independent from the numerology.

The numerology may be a communication parameter that is applied to at least one of the transmission or reception of a signal or channel. The numerology may indicate at least one of, for example, SubCarrier Spacing (SCS), bandwidth, symbol length, cyclic prefix length, transmission time interval (TTI), number of symbols per TTI, radio frame configuration, specific filtering processing performed by the transceiver in the frequency domain, or specific windowing processing performed by the transceiver in the time domain.

The slot may include one or more symbols in the time domain, such as OFDM (Orthogonal Frequency Division Multiplexing) symbols, SC-FDMA (Single Carrier Frequency Division Multiple Access) symbols, and the like. The slot may be a time unit based on the numerology.

The slot may include a plurality of mini slots. Each mini slot may include one or more symbols in the time domain. Further, the mini slot may be referred to as a sub-slot. The mini slot may include fewer symbols than the slot. PDSCH (or PUSCH) transmitted in time units greater than a mini slot may be referred to as PDSCH (or PUSCH) mapping type A. PDSCH (or PUSCH) transmitted using a mini slot may be referred to as PDSCH (or PUSCH) mapping type B.

A radio frame, a subframe, a slot, a mini slot and a symbol all represent time units for transmitting signals. Different terms may be used for referring to a radio frame, a subframe, a slot, a mini slot and a symbol, respectively.

For example, one subframe may be referred to as a transmission time interval (TTI), multiple consecutive subframes may be referred to as a TTI, and one slot or one mini slot may be referred to as a TTI. In other words, at least one of the subframe and the TTI may be a subframe (1 ms) in an existing LTE, a period shorter than 1 ms (e.g., 1-13 symbols), or a period longer than 1 ms. It should be noted that the unit representing the TTI may be referred to as a slot, a mini slot, or the like, rather than a subframe.

The TTI refers to, for example, the minimum time unit for scheduling in wireless communications. For example, in an LTE system, a base station schedules each terminal 20 to allocate radio resources (such as frequency bandwidth, transmission power, etc. that can be used in each terminal 20) in TTI units. The definition of TTI is not limited to the above.

The TTI may be a transmission time unit, such as a channel-encoded data packet (transport block), code block, codeword, or the like, or may be a processing unit, such as scheduling or link adaptation. It should be noted that, when a TTI is provided, the time interval (e.g., the number of symbols) during which the transport block, code block, codeword, or the like, is actually mapped may be shorter than the TTI.

It should be noted that, when one slot or one mini slot is referred to as a TTI, one or more TTIs (i.e., one or more slots or one or more mini slots) may be the minimum time unit for scheduling. Further, the number of slots (the number of mini slots) constituting the minimum time unit of the scheduling may be controlled.

A TTI having a time length of 1 ms may be referred to as a normal TTI (a TTI in LTE Rel. 8-12), a long TTI, a normal subframe, a long subframe, a slot, and the like. A TTI that is shorter than the normal TTI may be referred to as a shortened TTI, a short TTI, a partial TTI (or fractional TTI), a shortened subframe, a short subframe, a mini slot, a subslot, a slot, or the like.

It should be noted that the long TTI (e.g., normal TTI, subframe, etc.,) may be replaced with a TTI having a time length exceeding 1 ms, and the short TTI (e.g., shortened TTI, etc.,) may be replaced with a TTI having a TTI length less than the TTI length of the long TTI and a TTI length greater than 1 ms.

A resource block (RB) is a time domain and frequency domain resource allocation unit and may include one or more consecutive subcarriers in the frequency domain. The number of subcarriers included in an RB may be the same, regardless of the numerology, and may be 12, for example. The number of subcarriers included in an RB may be determined on the basis of numerology.

Further, the time domain of an RB may include one or more symbols, which may be 1 slot, 1 mini slot, 1 subframe, or 1 TTI in length. One TTI, one subframe, etc., may each include one or more resource blocks.

It should be noted that one or more RBs may be referred to as physical resource blocks (PRBs, Physical RBs), sub-carrier groups (SCGs), resource element groups (REGs), PRB pairs, RB pairs, and the like.

Further, a resource block may include one or more resource elements (RE). For example, 1 RE may be a radio resource area of one sub-carrier and one symbol.

The bandwidth part (BWP) (which may also be referred to as a partial bandwidth, etc.) may represent a subset of consecutive common RBs (common resource blocks) for a given numerology in a carrier. Here, a common RB may be identified by an index of RB relative to the common reference point of the carrier. A PRB may be defined in a BWP and may be numbered within the BWP.

BWP may include BWP for UL (UL BWP) and BWP for DL (DL BWP). For a terminal 20, one or more BWPs may be configured in one carrier.

At least one of the configured BWPs may be activated, and the terminal 20 may assume that the terminal 20 will not transmit and receive signals/channels outside the activated BWP. It should be noted that the terms “cell” and “carrier” in this disclosure may be replaced by “BWP.”

Structures of a radio frame, a subframe, a slot, a mini slot, and a symbol described above are exemplary only. For example, the number of subframes included in a radio frame, the number of slots per subframe or radio frame, the number of mini slots included in a slot, the number of symbols and RBs included in a slot or mini slot, the number of subcarriers included in an RB, the number of symbols in a TTI, the symbol length, the cyclic prefix (CP) length, and the like, may be changed in various ways.

In the present disclosure, where an article is added by translation, for example “a”, “an”, and “the”, the disclosure may include that the noun following these articles is plural.

In this disclosure, the term “A and B are different” may mean “A and B are different from each other.” It should be noted that the term “A and B are different” may mean “A and B are different from C.” Terms such as “separated” or “combined” may be interpreted in the same way as the above-described “different”.

Each aspect/embodiment described in the present specification may be used independently, may be used in combination, or may be used by switching according to operations. Further, notification (transmission/reporting) of predetermined information (e.g., notification (transmission/reporting) of “X”) is not limited to an explicit notification (transmission/reporting), and may be performed by an implicit notification (transmission/reporting) (e.g., by not performing notification (transmission/reporting) of the predetermined information).

As described above, the present invention has been described in detail. It is apparent to a person skilled in the art that the present invention is not limited to one or more embodiments of the present invention described in the present specification. Modifications, alternatives, replacements, etc., of the present invention may be possible without departing from the subject matter and the scope of the present invention defined by the descriptions of claims. Therefore, the descriptions of the present specification are for illustrative purposes only, and are not intended to be limitations to the present invention.

### DESCRIPTION OF THE REFERENCE NUMERALS

10 Base station
110 Transmission unit
120 Reception unit
130 Configuration unit
140 Control unit
20 Terminal
210 Transmission unit
220 Reception unit
230 Configuration unit
240 Control unit
1001 Processor
1002 Storage device
1003 Auxiliary storage device
1004 Communication device
1005 Input device
1006 Output device
2001 Vehicle
2002 Drive unit
2003 Steering unit
2004 Accelerator pedal
2005 Brake pedal
2006 Shift lever
2007 Front wheel
2008 Rear wheel
2009 Axle
2010 Electronic control unit
2012 Information service unit
2013 Communication module
2021 Current sensor
2022 Revolution sensor
2023 Pneumatic sensor
2024 Vehicle speed sensor
2025 Acceleration sensor
2026 Brake pedal sensor
2027 Shift lever sensor
2028 Object detection sensor
2029 Accelerator pedal sensor
2030 Driving support system unit
2031 Microprocessor
2032 Memory (ROM, RAM)
2033 Communication port (IO port)

1. A terminal comprising:
a communication unit configured to receive system information; and
a control unit configured to assume, based on the system information, that at least one of a downlink bandwidth part for a non-reduced function terminal that is different from that for a first function-reduced terminal; or an uplink bandwidth part for the non-reduced function terminal that is different from that for the first function-reduced terminal, is to be configured, wherein
a second function that is different from a first function for the first function-reduced terminal is reduced in the terminal.

2. The terminal as claimed in claim 1, wherein
the communication unit performs at least one of: transmission or reception related to a random access; transmission or reception in a connected mode; or paging reception and system information reception, by using the configured downlink bandwidth part or the configured uplink bandwidth part.

3. The terminal as claimed in claim 1, wherein
the control unit assumes that a center frequency of the downlink bandwidth part is equal to a center frequency of the uplink bandwidth part in a case where the downlink bandwidth part and the uplink bandwidth part are configured.

4. The terminal as claimed in claim 1, wherein
the control unit assumes that the configured downlink bandwidth part or the configured uplink bandwidth part is to be an active bandwidth part in a

5. A base station comprising:
a transmission unit configured to transmit system information to a terminal; and
a control unit configured to configure, based on the system information, to the terminal, at least one of a downlink bandwidth part for a non-reduced function terminal that is different from that for a first function-reduced terminal; or an uplink bandwidth part for the non-reduced function terminal that is different from that for the first function-reduced terminal, wherein
a second function that is different from a first function for the first function-reduced terminal is reduced in the terminal.

6. A communication method performed by a terminal comprising:
a communication unit configured to receive system information; and
a control unit configured to assume, based on the system information, that at least one of: a downlink bandwidth part for a non-reduced function terminal that is different from that for a first function-reduced terminal; or an uplink bandwidth part for the non-reduced function terminal that is different from that for the first function-reduced terminal, is to be configured, wherein
a second function that is different from a first function for the first function-reduced terminal is reduced in the terminal.
